(19) United States
(12) Patent Application Publication
(10) Pub. No.: US 2015/0067521 A1
(43) Pub. Date: Mar. 5, 2015

(54) METHOD AND APPARATUS FOR PRESENTING CONTENT USING ELECTRONIC DEVICES

(71) Applicant: Samsung Electronics Co., Ltd., Suwon-si (KR)

(72) Inventors: Jin HEO, Busan (KR); Keunha CHOI, Seoul (KR); Jimin KIM, Seoul (KR); Soohyung KIM, Hwaseong-si (KR); Hyunsoo KIM, Yongin-si (KR); Huncheol OH, Seoul (KR); Jinhong JEONG, Yongin-si (KR); Soonhyun CHA, Anyang-si (KR)

(21) Appl. No.: 14/471,659

(22) Filed: Aug. 28, 2014

(30) Foreign Application Priority Data
Aug. 30, 2013 (KR) 10-2013-0104101

(51) Int. Cl. G06F 3/0484; G06F 3/14

(52) U.S. Cl. CPC G06F 3/04847; G06F 3/04842; G06F 3/1423
USPC 715/733

(57) ABSTRACT

A method of selecting at least one device from among a plurality of electronic devices having first and second electronic devices, based on at least one of information about the plurality of electronic devices and a user input for at least one of the electronic devices is provided. The method includes presenting content through the plurality of electronic devices such that a first portion of the content is displayed through the first electronic device and a second portion of the content is displayed through the second electronic device. Also, this method includes performing a particular function associated with presentation of the content through the selected at least one device. Various other embodiments are possible.

### CROSS-REFERENCE TO RELATED APPLICATION(S)

This application claims the benefit under 35 U.S.C. §119(a) of a Korean patent application filed on Aug. 30, 2013 in the Korean Intellectual Property Office and assigned Serial No. 10-2013-0104101, the entire disclosure of which is hereby incorporated by reference.

### TECHNICAL FIELD

The present disclosure relate to a method and apparatus for presenting content through a plurality of electronic devices.

### BACKGROUND

Multi-vision is a technique that allows for displaying of the same content through several independent electronic devices. Since a display of a single electronic device may have a limited size, some content such as a large-sized image or video having a higher resolution may be often displayed using a plurality of electronic devices according to the multi-vision technique. Displaying content based on such a multi-vision technique may be useful for a variety of mobile devices, e.g., a mobile phone or a tablet, having a small-sized display for the purpose of portability.

According to an existing technique of constructing a multi-vision system, a number of electronic devices are disposed and, based on their locations, proper content sources are offered to respective electronic devices. For this, after the electronic devices are disposed at their locations, a link between a specific device offering a content source and the other devices should be set properly. Unfortunately, this may cause an inconvenience for a user.

Additionally, when a multi-vision system is realized using mobile devices such as a mobile phone or a tablet, it is difficult to cope with a specific event, e.g., the arrival of an incoming call, which may occur at a certain device during a display of content in a multi-vision mode. Furthermore, considering the nature of a mobile device that permits a free movement, the user of a certain device, even though being moved to any other space, should be able to continuously receive content at the same time as the users of the other devices. However, a multi-vision system of the related art has difficulty in supporting this aspect.

Accordingly, there is a need for an improved apparatus and method for toggling a content display mode such that at least one electronic device can present multi-vision content independently of the other devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, as aspect of the present disclosure is to provide methods and devices capable of freely toggling a content display mode such that at least one electronic device or electronic device group among a plurality of electronic devices that have presented certain content in a multi-vision mode can present such content independently of the other devices.

According to an aspect of the present disclosure, a content presenting method is provided. The method includes selecting at least one device from among a plurality of electronic devices having first and second electronic devices, based on at least one of information about the plurality of electronic devices and a user input for at least one of the electronic devices, presenting content through the plurality of electronic devices such that a first portion of the content is displayed through the first electronic device and a second portion of the content is displayed through the second electronic device, and performing a particular function associated with presentation of the content through the selected at least one device.

According to another aspect of the present disclosure, a content presenting method is provided. The method includes presenting content through a plurality of electronic devices having a first electronic device and a second electronic device such that a first portion of the content is displayed through the first electronic device and a second portion of the content is displayed through the second electronic device, adjusting, based on a user input for at least one of the plurality of electronic devices, at least one of the first and second portions, and based on the adjusting, displaying the first and second portions through the first and second electronic devices, respectively.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a content presenting system according to an embodiment of the present disclosure.

FIGS. 2A and 2B are schematic diagrams illustrating examples of displaying content in a content presenting system according to an embodiment of the present disclosure.

FIG. 3 is a schematic diagram illustrating examples in which an operating mode of at least some electronic devices in a content presenting system is changed from a multi-vision mode to a single-vision mode according to an embodiment of the present disclosure.

FIGS. 4A and 4B are schematic diagrams illustrating examples in which an operating mode of at least some electronic devices in a content presenting system is changed from a single-vision mode to a multi-vision mode according to an embodiment of the present disclosure.

FIG. 5 is a schematic diagram illustrating examples of displaying a plurality of contents in a content presenting system according to an embodiment of the present disclosure.

FIG. 6 is a schematic diagram illustrating an example of displaying a control interface of content on at least some electronic devices in a content presenting system according to an embodiment of the present disclosure.

FIG. 7 is a schematic diagram illustrating another example of displaying a control interface of content on at least some electronic devices in a content presenting system according to an embodiment of the present disclosure.

FIG. 8 is a schematic diagram illustrating an example of providing a specific service corresponding to a notification event through any other electronic device when the notification event happens at one of electronic devices in a content presenting system according to an embodiment of the present disclosure.

FIG. 9 is a schematic diagram illustrating an example of adjusting content correspondingly at respective electronic devices in response to a user input entered in at least some of the electronic devices in a content presenting system according to an embodiment of the present disclosure.

FIG. 10 is a block diagram illustrating an electronic device for presenting content according to an embodiment of the present disclosure.

FIG. 11 is a block diagram illustrating a master electronic device and a slave electronic device in a content presenting system according to an embodiment of the present disclosure.

FIG. 12 is a block diagram illustrating a multi-vision module of an electronic device according to an embodiment of the present disclosure.

FIG. 13 is a block diagram illustrating a display module of an electronic device in accordance with embodiments of the present disclosure.

FIG. 14 is a flow diagram illustrating a process of adding a connection with a slave in a content presenting system according to an embodiment of the present disclosure.

FIG. 15 is a flow diagram illustrating a process of removing a connection with a slave in a content presenting system according to an embodiment of the present disclosure.

FIG. 16 is a flow diagram illustrating a process of dividing content into portions according to an embodiment of the present disclosure.

FIG. 17 is a flow diagram illustrating a method for synchronizing a plurality of electronic devices in a content presenting system according to an embodiment of the present disclosure.

FIG. 18 is a flow diagram illustrating a method for adjusting a content portion in a multi-vision mode according to an embodiment of the present disclosure.

FIG. 19 is a flow diagram illustrating a process of displaying a plurality of contents at a plurality of multi-vision groups according to an embodiment of the present disclosure.

FIG. 20 is a flow diagram illustrating a method for controlling a multi-vision group to display an interface for providing an additional function through at least one electronic device according to an embodiment of the present disclosure.

FIG. 21 is a flow diagram illustrating a method for controlling a multi-vision group to display an interface for providing any other function to part of a display region of at least one electronic device according to an embodiment of the present disclosure.

FIG. 22 is a flow diagram illustrating a method for controlling a multi-vision group to display a notification event, which happens at one electronic device, on any other selected device according to an embodiment of the present disclosure.

FIG. 23 is a flow diagram illustrating a method for presenting content in accordance with an embodiment of the present disclosure.

FIG. 24 is a flow diagram illustrating a method for presenting content according to an embodiment of the present disclosure.

FIG. 25 is a flow diagram illustrating a method for presenting content according to an embodiment of the present disclosure.

FIG. 26 is a block diagram illustrating an electronic device according to an embodiment of the present disclosure.

FIG. 27 is a block diagram illustrating hardware according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “content” includes reference to one or more of such contents.

In this disclosure, an electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a portable medical device, a digital camera, or a wearable device (e.g., a Head-Mounted Device (HMD) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a TV, a Digital Video Disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), an Flight Data Recorder (FDR), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

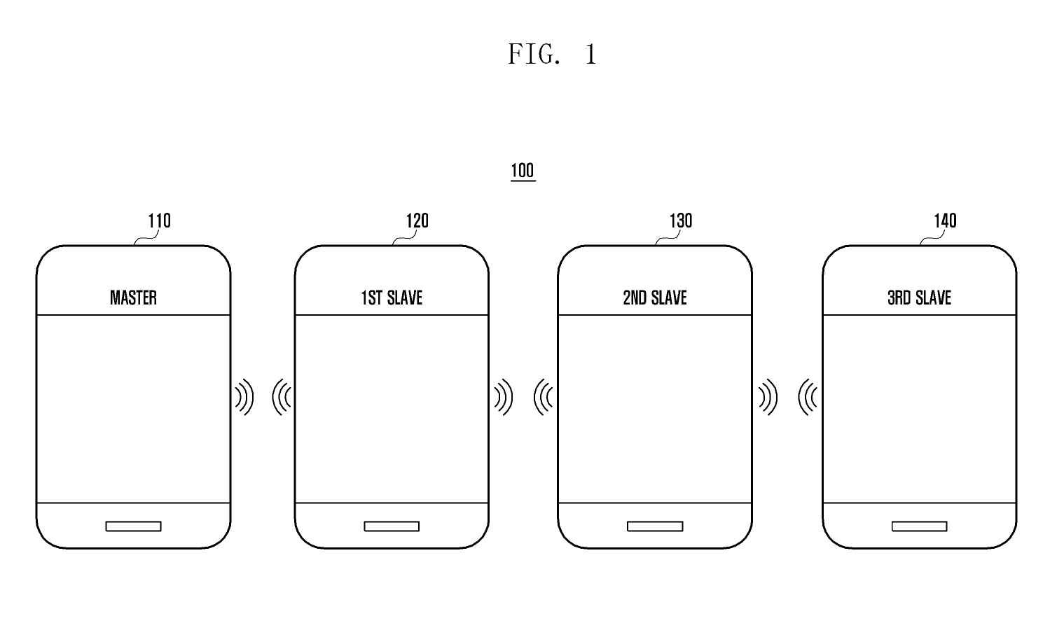

FIG. 1 is a schematic diagram illustrating a content presenting system according to an embodiment of the present disclosure.

Referring to FIG. 1, a content presenting system 100 may simultaneously present (e.g., display or otherwise provide) content through a plurality of electronic devices. The content presenting system 100 may include a plurality of electronic devices, e.g., a master 110, a first slave 120, a second slave 130, and a third slave 140, which have the ability, through a functional connection (e.g., a communication), to simultaneously (e.g., display or otherwise provide) present content. Although FIG. 1 shows the content presenting system 100 having three slaves 120, 130 and 140, this is exemplary only and not to be considered as a limitation of the present disclosure. Alternatively, one or more slaves may be flexibly used for the content presenting system 100.

The master 110 may create control information corresponding to respective individual electronic devices in the content presenting system 100. Additionally, the master 110 may transmit control information corresponding to each electronic device (i.e., the slaves 120, 130 and 140) to the other electronic devices in the content presenting system 100. For this, the master 110 may establish a communication channel for transmission of control information. A communication channel may comply with various standards such as WiFi-direct, WiFi, Bluetooth, Near Field Communication (NFC), Device-To-Device (DTD), 3G/4G/LTE (Long Term Evolution), and the like, without being limited to any specific communication protocol.

According to an embodiment, at least some control information may include synchronization information used for synchronizing time associated with content presentation between at least parts of electronic devices, e.g., the master 110, the first slave 120, the second slave 130 and the third slave 140, which belong to the content presenting system 100. Through synchronization information, the electronic devices 110-140 in the content presenting system 100 may be synchronized with each other and thereby present content simultaneously. For example, the first, second and third slaves 120, 130 and 140 may be synchronized with the master 110. Therefore, even though the slaves 120, 130 and 140 fail to transmit and receive a synchronization signal to and from each other, the simultaneous presentation of content may be possible.

According to a certain embodiment, specific content to be simultaneously presented through the master 110, the first slave 120, the second slave 130 and the third slave 140 may be stored in the master 110. In this case, the master 110 may transmit specific content to the other electronic devices (e.g., the slaves 120, 130 and 140), together with or regardless of control information. Additionally, the master 110 may transmit original data of content or encoded signals thereof to such slaves.

According to a certain embodiment, the master 110 may provide specific content stored therein to other electronic devices (e.g., the slaves 120, 130 and 140) in the content presenting system 100 together with or regardless of control information. The master 110 may transmit original data of content or encoded signals thereof to such slaves.

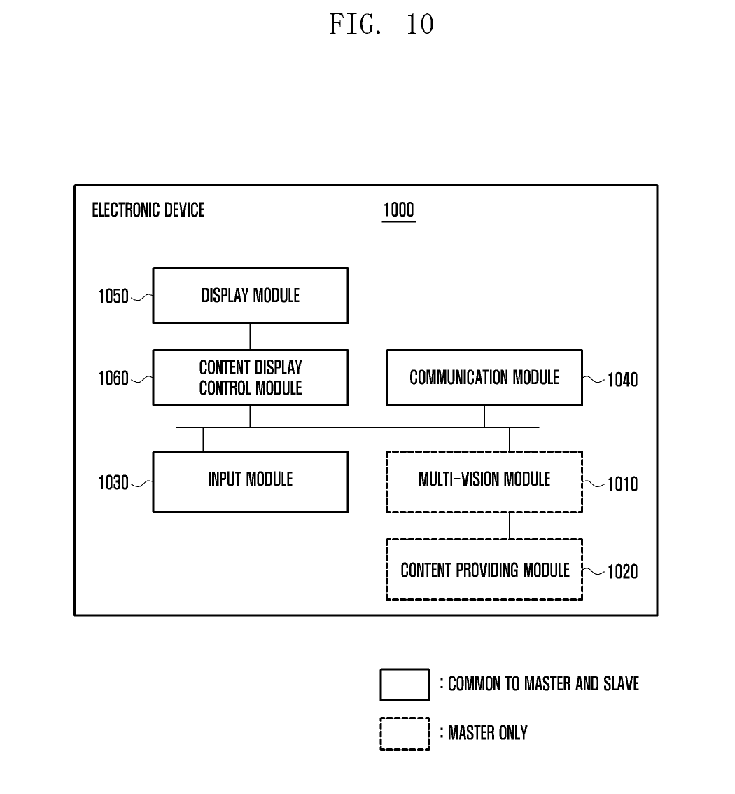

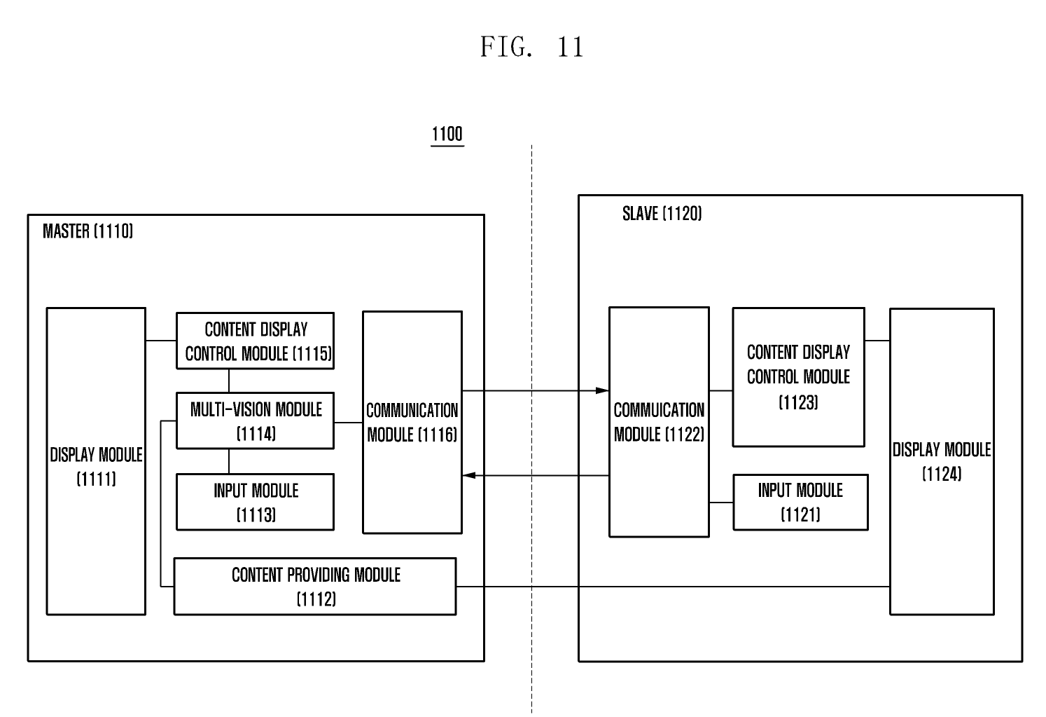

According to an embodiment, the master 110 may drive a content providing module (e.g., HyperText Transfer Protocol (HTTP) server) for providing content through a communication connection (e.g., Transmission Control Protocol (TCP) that guarantees the reliability with other electronic devices (e.g., the slaves 120, 130 and 140) in the content presenting system 100. This content providing module may be a specific module functionally connected to the master 110. If the volume of content is greater than a reference value (for example, in case of multimedia content), an additional content providing module may be used. The master 110 may transmit link information (e.g., URL), which allows for receiving content through access to such a content providing module, to other electronic devices (e.g., the slaves 120, 130 and 140) in the content presenting system 100 together with or regardless of control information. A detailed description about the content providing module will be given later with reference to FIGS. 10 and 11.

According to an embodiment, other electronic devices (e.g., the slaves 120, 130 and 140) in the content presenting system 100 may receive content stored in the master 110 (e.g., through download, streaming, etc.), based on link information received from the master 110. Alternatively or additionally, content to be presented simultaneously through the electronic devices 110, 120, 130 and 140 in the content presenting system 100 may be content stored in any external server (e.g., a file server, a content provider, an Access Point (AP), a base station, etc.). The master 110 may obtain link information (e.g., URL) which allows for receiving content through access to such an external server, and may transmit the link information to other electronic devices (e.g., the slaves 120, 130 and 140) in the content presenting system 100 together with or regardless of control information. The master 110 and the slaves 120, 130 and 140 may access a selected external server using such link information and receive content from the accessed server (e.g., through download or streaming).

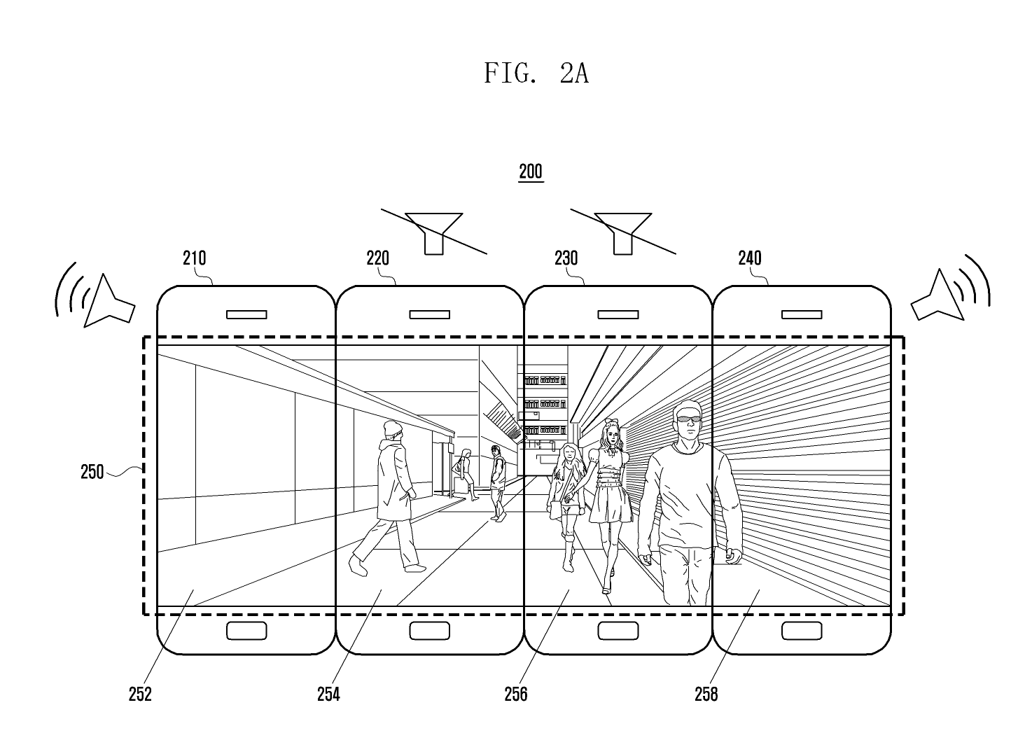

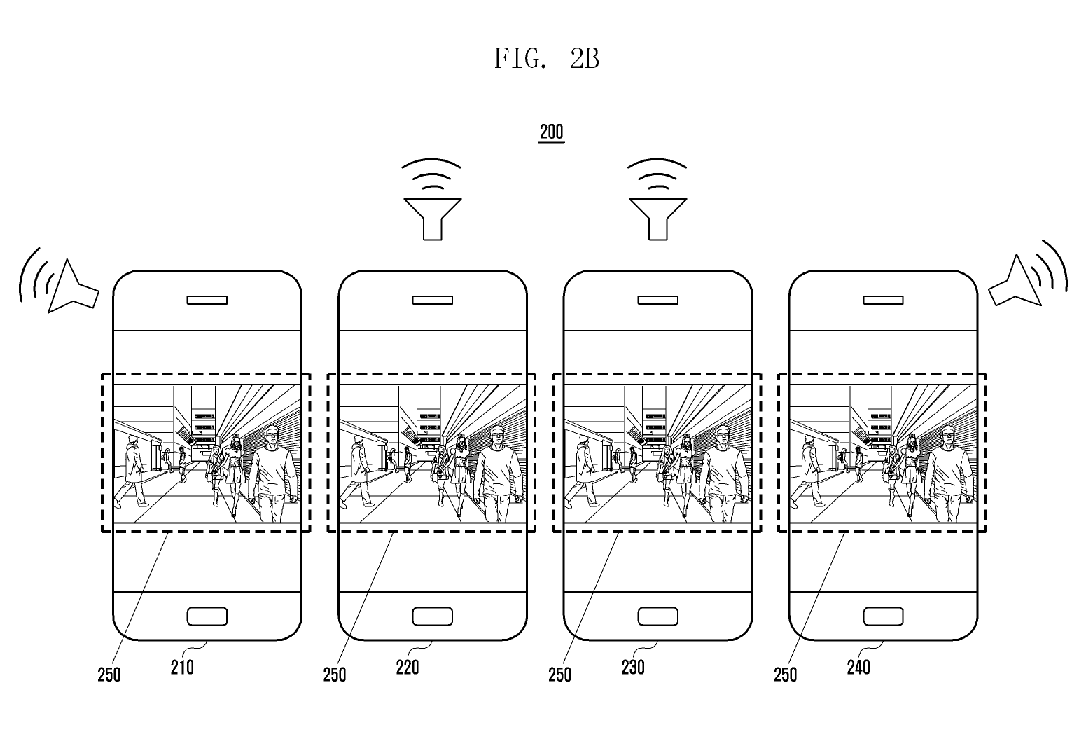

FIGS. 2A and 2B are schematic diagrams illustrating examples of displaying content in a content presenting system according to an embodiment of the present disclosure.

According to various embodiments, the content presenting system 200 of FIGS. 2A and 2B may be the content presenting system 100 discussed above and shown in FIG. 1. For example, a first electronic device 210, a second electronic device 220, a third electronic device 230 and a fourth electronic device 240 in the content presenting system 200 may correspond respectively to the master 110, the first slave 120, the second slave 130 and the third slave 140 shown in FIG. 1.

Referring to FIG. 2A, each of the electronic devices 210, 220, 230 and 240 may display a corresponding portion of content among a plurality of portions obtained by dividing given content. Since respective individual electronic devices simultaneously display divided portions of content thereon, the content presenting system 200 may visually offer given content as a combination of divided portions of content to a user. For example, content 250 may have the first display portion 252, the second display portion 254, the third display portion 256, and the fourth display portion 258, which correspond to the first electronic device 210, the second electronic device 220, the third electronic device 230, and the fourth electronic device 240, respectively.

In case the respective electronic devices 210, 220, 230 and 240 of the content presenting system 200 operate in a multi-vision mode, such electronic devices 210, 220, 230 and 240 may display given content 250 in cooperation with each other as shown in FIG. 2A. Namely, in a multi-vision mode, the electronic devices 210, 220, 230 and 240 of the content presenting system 200 may display thereon such corresponding divided portions 252, 254, 256 and 258, respectively and simultaneously. This simultaneous display of divided portions of content may allow for the presentation of content 250 with a much larger screen than a size-limited screen of an individual electronic device.

In the content presenting system 200, at least one (e.g., the first electronic device 210) of the electronic devices 210, 220, 230 and 240 may store an electronic device list that contains therein information about such electronic devices. In case the electronic devices 210, 220, 230 and 240 display content in a multi-vision mode as shown in FIG. 2A, the electronic device list may contain, as part of information about electronic devices, location information that indicates relative locations of the respective electronic devices 210, 220, 230 and 240. According to various embodiments, location information of an electronic device operating in a multi-vision mode may be set as a numeric form indicating the order of arrangement from left to right. For example, location information of the electronic devices 210, 220, 230 and 240 may be set to “1”, “2”, “3” and “4”, respectively.

According to an embodiment, the content 250 may include multimedia content that contains therein audio (e.g., background music, character's lines, etc.) associated with at least part of the display portions 252, 254, 256 and 258. In this case, a certain electronic device (e.g., the first electronic device 210) corresponding to the master of the content presenting system 200 may output audio of content through at least one (e.g., the first electronic device group including the first and fourth electronic devices 210 and 240) of electronic devices 210, 220, 230 and 240, based on location information of such electronic devices 210, 220, 230 and 240 that operate in a multi-vision mode. Namely, in this case, the other electronic devices (e.g., the second electronic device group including the second and third electronic devices 220 and 230) may fail to output audio of content. According to another embodiment, some electronic devices and the others may output audio by turns. According to still another embodiment, the respective electronic devices 210, 220, 230 and 240 may output audio at the same time.

Referring to FIG. 2B, each of the electronic devices 210, 220, 230 and 240 in the content presenting system 200 may independently display given content 250. Namely, in case the respective electronic devices 210, 220, 230 and 240 operate in a single-vision mode, each of the electronic devices 210, 220, 230 and 240 may display given content 250 independently of each other as shown in FIG. 2B.

According to various embodiments, when the electronic devices 210, 220, 230 and 240 display content in a single-vision mode, location information that indicates relative locations of the respective electronic devices 210, 220, 230 and 240 may be set to a default value (e.g., “−1”) which is distinguishable from location information of electronic devices operating in a multi-vision mode.

According to various embodiments, an operating mode (e.g., an input mode or an output mode) of each electronic device 210, 220, 230 or 240 in the content presenting system 200 may be defined as one of a multi-vision mode and a single-vision mode. Further, an operating mode of each electronic device 210, 220, 230 or 240 may be toggled between a multi-vision mode and a single-vision mode in response to a user input. This may realize a flexible content presenting system.

According to various embodiments, regardless of an operating mode, each of the electronic devices 210, 220, 230 and 240 in the content presenting system 200 may display content (e.g., a corresponding display portion in case of a multi-vision mode or entire content 250 in case of a single-vision mode) with the same format (e.g., size, resolution, brightness, color, shape, etc.). Alternatively, some electronic devices may display content with different formats from the others. Additionally, regardless of an operating mode, each of the electronic devices 210, 220, 230 and 240 in the content presenting system 200 may display content at the same time. Alternatively, some electronic devices may display content at different times from the others.

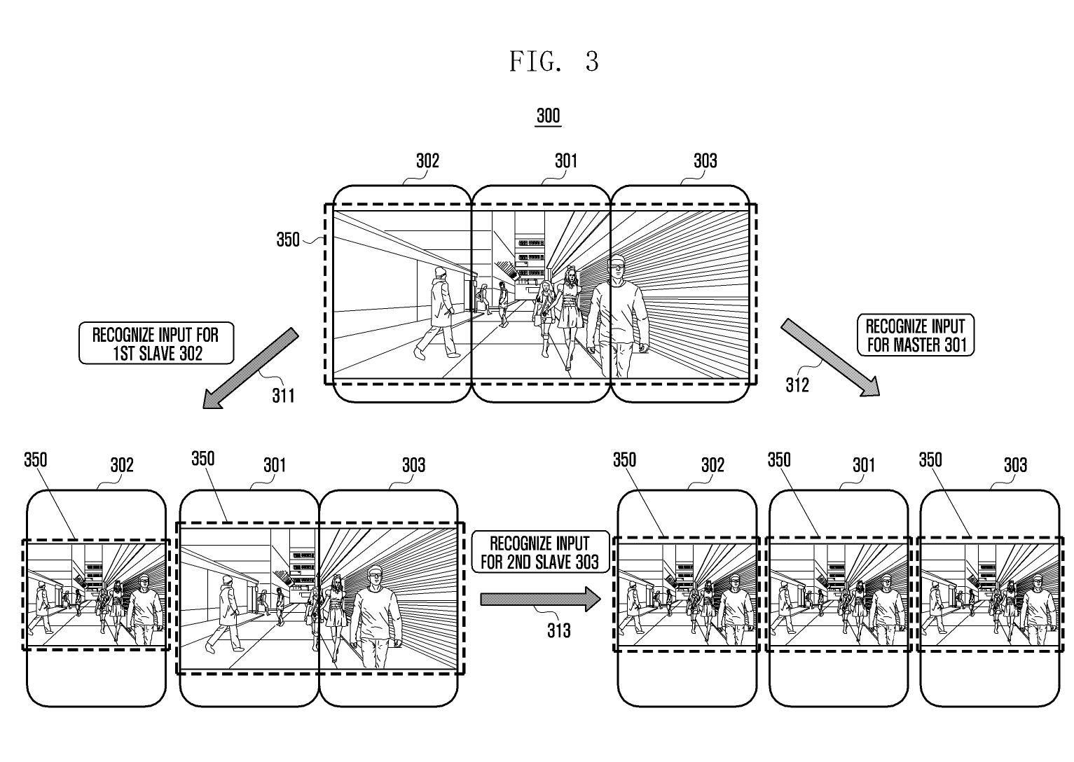

FIG. 3 is a schematic diagram illustrating examples in which an operating mode of at least some electronic devices in a content presenting system is changed from a multi-vision mode to a single-vision mode according to an embodiment of the present disclosure.

According to various embodiments, the content presenting system 300 of FIG. 3 may be the content presenting system 100 discussed above and shown in FIG. 1 or the content presenting system 200 discussed above and shown in FIG. 2.

Referring to FIG. 3, the content presenting system 300 may include a master 301, a first slave 302, and a second slave 303. According to various embodiments, the first slave 302, the master 301 and the second slave 303, disposed from left to right as shown in FIG. 3, may operate together in a multi-vision mode. In this case, the location information of the master 301, the first slave 302 and the second slave 303 may be set to “2”, “1” and “3”, respectively. According to alternative embodiments, such electronic devices that constitute the content presenting system 300 may be disposed in a different order. For example, the order of the master 301, the first slave 302 and the second slave 303 from left to right may be possible. In this case, the location information of the master 301, the first slave 302 and the second slave 303 may be set to “1”, “2” and “3”, respectively. According to various embodiments, all of the electronic devices combined with each other may be disposed horizontally as shown in FIG. 3 or vertically. Alternatively, at least one of the electronic devices may be disposed horizontally and the others vertically, and vice versa. The location information of such electronic devices may be set to indicate a rightward, leftward, downward, or upward order or their combination or any other arbitrary order.

At operation 311, if an input for toggling an operating mode to a single-vision mode is recognized (e.g., detected) for the first slave 302 disposed at the leftmost location among all the electronic devices 301, 302 and 303 operating in a multi-vision mode, the operating mode of the first slave 302 only may be changed from a multi-vision mode to a single-vision mode. The input may be detected at the master, at the specific electronic device for which the mode is being modified, at one or more of the electronic devices 301, 302, and 303, or the like. This input may be a predefined user input such as a shaking action, a touch, a hovering gesture or a voice input, or an automatic system command caused by the expiration of a predefined time. In this case, specific information 350 (e.g., text, a still image, or a video) displayed on the electronic devices 301, 302 and 303 in a multi-vision mode may be displayed independently on the first electronic device group (i.e., the first slave 302) changed to a single-vision mode and on the second electronic device group (i.e., the master 301 and the second slave 303) remaining in a multi-vision mode. Additionally, depending on a change in the operating mode of the first slave 302, the location information of all the electronic devices 301, 302 and 303 may be also changed. For example, the location information of the master 301, the first slave 302 and the second slave 303 may be changed to “1”, “−1” and “2”, respectively.

At operation 312, if an input for toggling an operating mode to a single-vision mode is recognized (e.g., detected) for the master 301 among all the electronic devices 301, 302 and 303 operating in a multi-vision mode, the operating mode of all the electronic devices 301, 302 and 303 may be changed from a multi-vision mode to a single-vision mode. In this case, specific information 350 (e.g., text, a still image, or a video) displayed on the electronic devices 301, 302 and 303 in a multi-vision mode may be displayed independently on each of the master 301 and the first and second slaves 302 and 303, all of which are changed to a single-vision mode. Additionally, depending on a change in the operating mode of the master 301, the location information of all the electronic devices may be also changed. For example, the location information of the master 301, the first slave 302 and the second slave 303 may be changed to “−1”, “−1” and “−1”, respectively.

Meanwhile, at operation 313, if an input for toggling an operating mode to a single-vision mode is recognized (e.g., detected) for the second slave 303 disposed at the right location between both electronic devices 301 and 303 operating in a multi-vision mode, the operating mode of the second slave 303 may be changed from a multi-vision mode to a single-vision mode. In this case, the master 301 left alone in a multi-vision mode may automatically change the operating mode thereof from a multi-vision mode to a single-vision mode. Therefore, specific information 350 (e.g., text, a still image, or a video) displayed on the electronic devices 301, 302 and 303 in a multi-vision mode may be displayed independently on each of the master 301 and the first and second slaves 302 and 303 all of which are changed to a single-vision mode. Additionally, the location information of the electronic devices previously operating in a multi-vision mode may be changed again. For example, the location information of the master 301 and the second slave 303 may be changed to “−1” and “−1”, respectively.

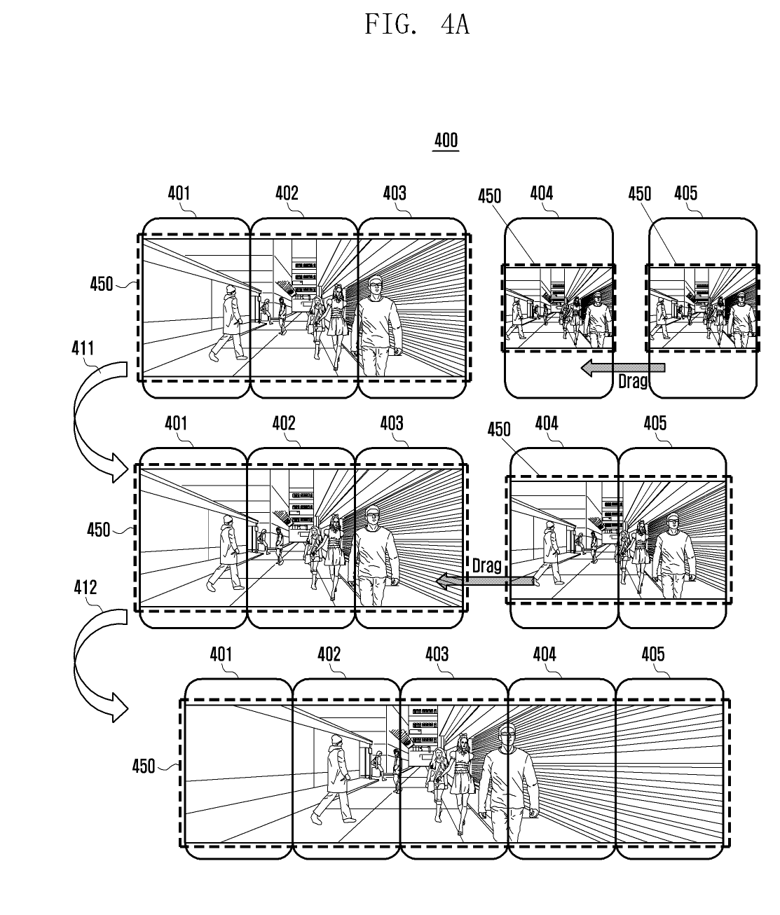

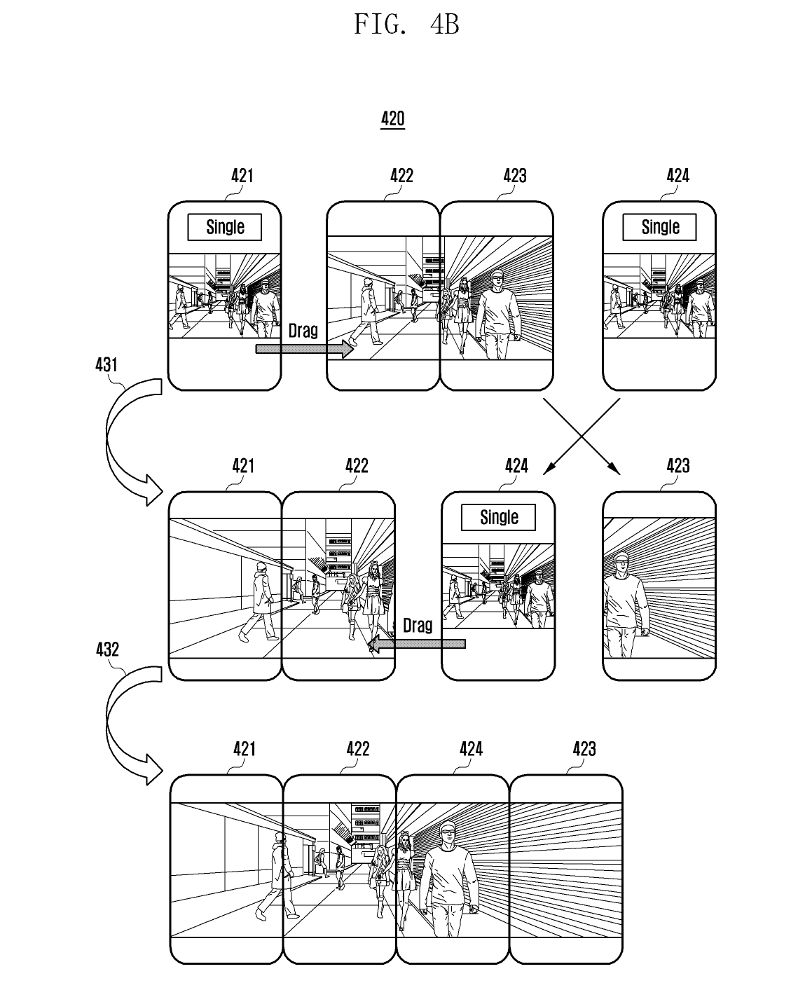

FIGS. 4A and 4B are schematic diagrams illustrating examples in which an operating mode of at least some electronic devices in a content presenting system is changed from a single-vision mode to a multi-vision mode according to an embodiment of the present disclosure.

In various embodiments of the present disclosure, the content presenting system 400 of FIGS. 4A and 4B may be the content presenting system 100, 200 or 300 discussed above.

Referring FIG. 4A, the content presenting system 400 may include a first electronic device 401, a second electronic device 402, a third electronic device 403, a fourth electronic device 404, and a fifth electronic device 405. According to various embodiments, the first, second and third electronic devices 401, 402 and 403 form the first electronic device group that operates in a multi-vision mode, whereas the fourth and fifth electronic devices 404 and 405 may operate individually in a single-vision mode. In this case, as shown in the upper part of FIG. 4A, each of the first electronic device group, the fourth electronic device 404 and the fifth electronic device 405 may present given content 450 independently of each other. Additionally, the location information of the first, second, third, fourth and fifth electronic devices 401, 402, 403, 404 and 405 may be set to “1”, “2”, “3”, “−1” and “−1”, respectively.

At operation 411, an input for toggling an operating mode to a multi-vision mode may be recognized (e.g., detected) for the electronic devices 404 and 405 that operate in a single-vision mode. This input may be a predefined user input (e.g., a drag input from a part of an input panel of the fourth electronic device 404 to a part of an input panel of the fifth electronic device 405, or a sequential touch on each input panel of both electronic devices), or an automatic system command (e.g., caused by the expiration of a predefined time in a master electronic device or in the fifth electronic device 405). In response to such an input, the operating mode of the electronic devices 404 and 405 may be changed simultaneously or sequentially from a single-vision mode to a multi-vision mode. In this case, the electronic devices 404 and 405, the operating mode of which is changed from a single-vision mode to a multi-vision mode, may form the second electronic device group distinguished from the first electronic device group formed by the other electronic devices 401, 402 and 403 which have already operated in a multi-vision mode. As shown in the middle part of FIG. 4A, each of the first and second electronic device groups may operate in a multi-vision mode and thus display given content 450 independently of each other. According to various embodiments, as discussed above, the content presenting system may create a new multi-vision group (e.g., the second electronic device group) by selectively coupling some electronic devices that operate in a single-vision mode. Namely, a plurality of multi-vision groups (e.g., the first and second electronic device groups) may be formed. In an example shown in FIG. 4A, the first electronic device group including therein the first, second and third electronic devices 401, 402 and 403 may form the first multi-vision group, and the second electronic device group including therein the fourth and fifth electronic devices 404 and 405 may form the second multi-vision group.

Since two or more multi-vision groups may be used, an electronic device list may contain multi-vision group information as well as location information of each electronic device. For example, multi-vision group information of certain electronic devices that operate in a single-vision mode may be set to a default value (e.g., “−1”) which is distinguishable from multi-vision group information of electronic devices that operate in a multi-vision mode. For example, at operation 411 discussed above, a pair of the multi-vision group information and the location information in the fourth and fifth electronic devices 404 and 405 may be changed from (−1, −1) and (−1, −1) to (2, 1) and (2, 2), respectively.

At operation 412, if an input for toggling an operating mode to a multi-vision mode is recognized (e.g., detected) for at least one of the electronic devices in the first multi-vision group (e.g., the third electronic device 403) or for at least one of the electronic devices in the second multi-vision group (e.g., the fourth electronic device 404), the electronic devices that operate as different multi-vision groups may be unified into one multi-vision group. In this case, as shown in the lower part of FIG. 4A, a newly unified multi-vision group (e.g., one electronic device group including the first to fifth electronic devices 401 to 405) may present given content 450 in a unified form. At this operation 412, for example, a pair of the multi-vision group information and the location information in the fourth and fifth electronic devices 404 and 405 may be changed from (2, 1) and (2, 2) to (1, 4) and (1, 5), respectively.

Referring FIG. 4B, a content presenting system 420 may include a first electronic device 421, a second electronic device 422, a third electronic device 423, and a fourth electronic device 424. Among these electronic devices, the second and third electronic devices 422 and 423 may operate in a multi-vision mode, and the first and fourth electronic devices 421 and 424 may operate in a single-vision mode. For example, the location information of the first, second, third and fourth electronic devices 421, 422, 423 and 424 may be set to “−1”, “1”, “2” and “−1”, respectively.

At operation 431, if a user input (e.g., a drag input from a part of an input panel of the first electronic device 421 to a part of an input panel of the second electronic device 422) for toggling an operating mode to a multi-vision mode is recognized (e.g., detected) for the electronic device (e.g., the first electronic device 421) that operates in a single-vision mode, the operating mode of the electronic device (e.g., the first electronic device 421) operating in a single-vision mode from among electronic devices corresponding to the user input may be changed from a single-vision mode to a multi-vision mode. In this case, based on information (e.g., a recognition time and direction of a drag input) about the user input recognized (e.g., detected) at each electronic device (e.g., the first and second electronic device 421 and 422) corresponding to the user input, it is possible to determine a multi-vision group and a location therein.

According to various embodiments, by comparing a recognition time of a drag input at each electronic device corresponding to the user input, a certain electronic device operating in a single-vision mode or belonging to other multi-vision group, from among electronic devices corresponding to the user input, may be added to a specific multi-vision group to which the last electronic device recognizing the drag input belongs. For example, at operation 431, the first electronic device 421 operating in a single-vision mode may be added to a multi-vision group to which the second electronic device 422, i.e., the last electronic device recognizing the drag input, belongs.

According to various embodiments, based on a drag direction recognized (e.g., detected) at the last electronic device that recognizes a drag input, the location information of an electronic device added to a multi-vision group may be determined. For example, at operation 431 discussed above, the second electronic device 422 that recognizes a drag direction as a rightward direction may set the location information of the first electronic device 421, added to a multi-vision group, to “1” which indicates the left location of the second electronic device 422. Additionally, the location information of the second and third electronic devices 422 and 423 which are located at the right location of the first electronic device 421 may be increased by one that corresponds to the number of added electronic devices. Namely, the location information of the second and third electronic devices 422 and 423 may be changed to “2” and “3”, respectively.

At operation 432, if a user input (e.g., a drag input from a part of an input panel of the fourth electronic device 424 to a part of an input panel of the second electronic device 422) for toggling an operating mode to a multi-vision mode is recognized (e.g., detected) for the electronic device (e.g., the fourth electronic device 424) that operates in a single-vision mode, the operating mode of the electronic device (e.g., the fourth electronic device 424) operating in a single-vision mode from among electronic devices corresponding to the user input may be changed from a single-vision mode to a multi-vision mode.

At this operation 432, for example, the fourth electronic device 424 that operates in a single-vision mode may be added to a multi-vision group to which the second electronic device 422, which is the last electronic device recognizing a drag input, belongs. In this case, the second electronic device 422 may recognize a drag direction as a leftward direction and set the location information of the fourth electronic device 424, added to a multi-vision group, to “3” which indicates the right location of the second electronic device 422. Additionally, the location information of the third electronic device 423 which is located at the right location of the fourth electronic device 424 may be increased by one that corresponds to the number of added electronic devices and thus changed to “4”.

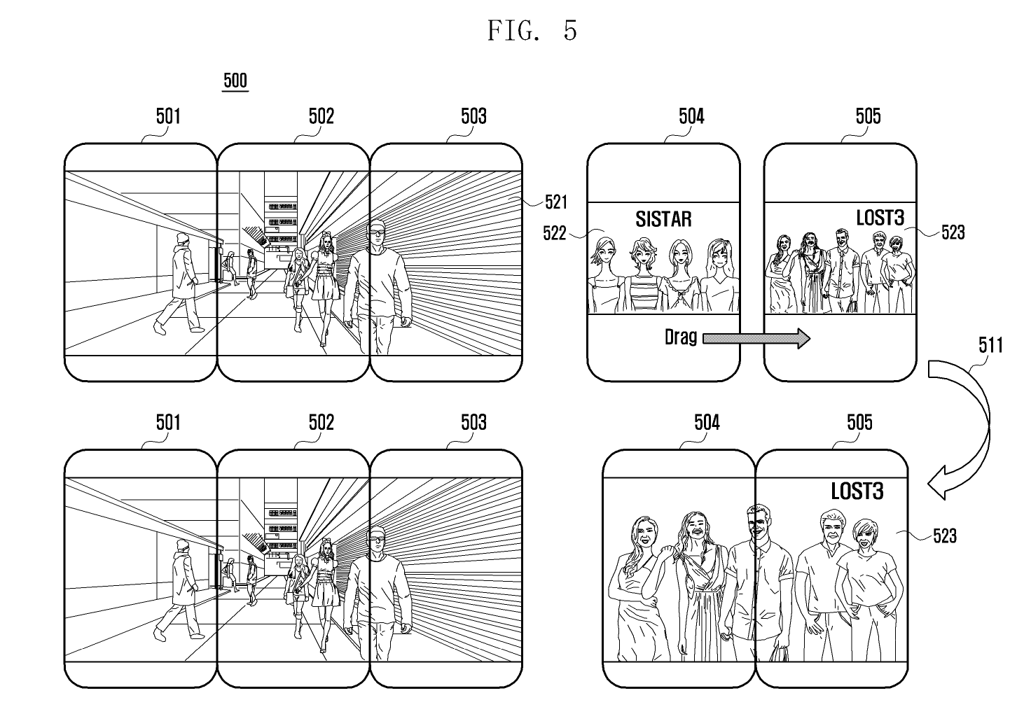

FIG. 5 is a schematic diagram illustrating examples of displaying a plurality of contents in a content presenting system according to an embodiment of the present disclosure.

In various embodiments of the present disclosure, the content presenting system 500 of FIG. 5 may be the content presenting system 100 or 200 discussed above.

Referring FIG. 5, the content presenting system 500 may include a first electronic device 501, a second electronic device 502, a third electronic device 503, a fourth electronic device 504, and a fifth electronic device 505. Among them, the first, second and third electronic devices 501, 502 and 503 may operate in a multi-vision mode, whereas the fourth and fifth electronic devices 504 and 505 may operate individually in a single-vision mode. For example, a pair of the multi-vision group information and the location information of the first, second, third, fourth and fifth electronic devices 501, 502, 503, 504 and 505 may be set to (1, 1), (1, 2), (1, 3), (−1, −1) and (−1, −1), respectively.

According to various embodiments, as shown in FIG. 5, the first multi-vision group including the first to third electronic devices 501 to 503, the fourth electronic device 504, and the fifth electronic device 505 may display the first content 521, the second content 522, and the third content 523, respectively, which are different from each other. According to another embodiment, the first multi-vision group that operates in a multi-vision mode may output specific data corresponding to the first playback point (e.g., the time point after one minute passed) of given content (e.g., five minutes-long multimedia content), whereas the fourth and fifth electronic devices 504 and 504 that individually operate in a single-vision mode may output other specific data corresponding to the second and third playback points (e.g., the time point after two minutes passed and the time point after three minutes passed) of the same content, respectively.

At operation 511, if a user input (e.g., a drag from a part of the fourth electronic device 504 to a part of the fifth electronic device 505) for toggling an operating mode to a multi-vision mode is recognized (e.g., detected) for the electronic devices 504 and 505 that operate in a single-vision mode, such electronic devices 504 and 505 may operate simultaneously in a multi-vision mode. In this case, the mode-changed electronic devices 504 and 505 form the second multi-vision group which is different from the first multi-vision group composed of the first to third electronic devices 501 to 503. Different multi-vision groups may display different contents independently of each other.

According to various embodiments, in case the electronic devices 504 and 505 receiving the above-discussed user input (e.g., a drag) as shown in FIG. 5 output different contents (e.g., the second and third contents 522 and 523) or output different specific data corresponding to different playback points (e.g., the time point after two minutes passed and the time point after three minutes passed) of the same content, such different contents or different playback points may be selected for a multi-vision mode. For example, the content (e.g., the third content 523) or playback point (e.g., the time point after three minutes passed) of the last electronic device that recognizes a drag input may be selected to be displayed in a multi-vision mode.

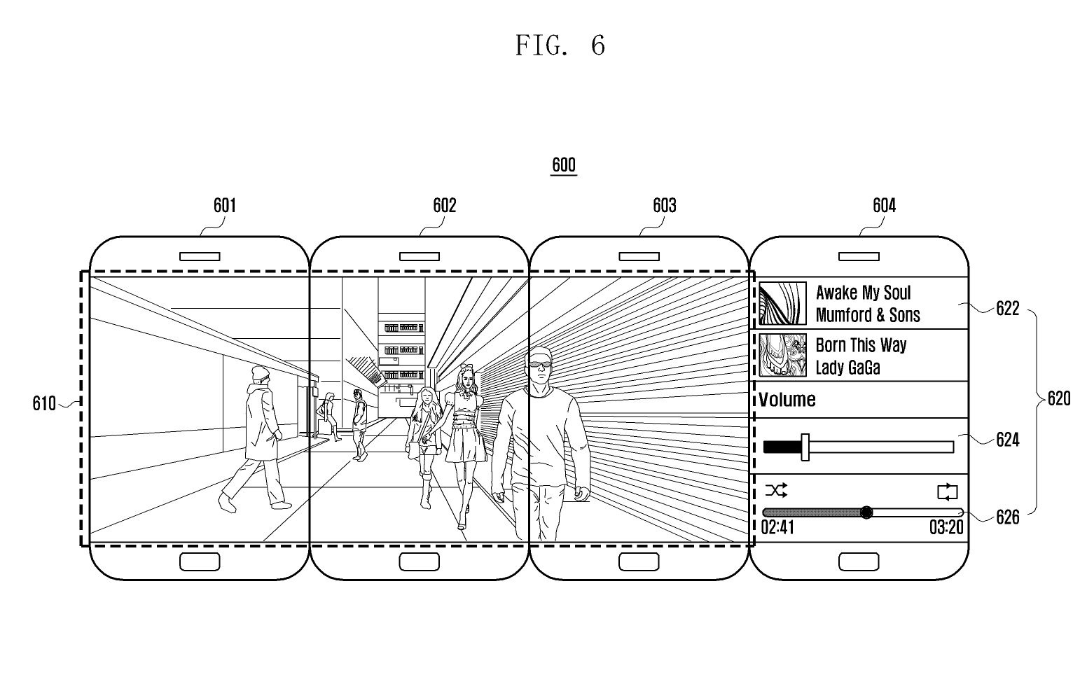

FIG. 6 is a schematic diagram illustrating an example of displaying a control interface of content on at least some electronic devices in a content presenting system according to an embodiment of the present disclosure.

In various embodiments of the present disclosure, the content presenting system 600 of FIG. 6 may be the content presenting system 100 or 200 discussed above.

Referring FIG. 6, the content presenting system 600 may include a first electronic device 601, a second electronic device 602, a third electronic device 603, and a fourth electronic device 604. All the electronic devices 601, 602, 603 and 604 may operate in a multi-vision mode. The location information of the first, second, third and fourth electronic devices 601, 602, 603 and 604 may be set to “1”, “2”, “3” and “4”, respectively.

According to various embodiments, as shown in FIG. 6, some electronic devices may display given content 610 in a multi-vision mode, whereas the other electronic device(s) may display thereon a control interface 620 for receiving display control commands (e.g., a play, a seek, a pause, a stop, etc.) regarding the content from a user.

According to various embodiments, any electronic device designated by a user input may be selected as a specific electronic device for displaying the control interface 620. According to another embodiment, based on the location information of an electronic device operating in a multi-vision mode, a specific electronic device for displaying the control interface 620 may be selected. For example, as shown in FIG. 6, a certain electronic device having the greatest number set as the location information (e.g., the fourth electronic device 604) may be selected as a specific electronic device for displaying the control interface 620.

According to various embodiments, the control interface 620 may contain therein at least one of a playable content list 622, a volume adjusting bar 624, a progressive bar 626, and control buttons (not shown) corresponding to display control commands (e.g., a play, a seek, a pause, a stop, etc.).

According to various embodiments, the optimal number of multi-vision mode electronic devices adapted to the resolution of content may be determined (e.g., calculated). Based on this optimal number, it is possible to determine whether to display the control interface 620 through at least one of the electronic devices 601, 602, 603 and 604 in the content presenting system 600. For example, at least one of multi-vision mode electronic devices may be selected as an electronic device for displaying the control interface 620 on the basis of a location or a display size of each multi-vision mode electronic device. In this case, one of the electronic devices operating as a slave (e.g., the above-discussed slaves 120, 130 and 140 in FIG. 1) or an electronic device operating as a master (e.g., the above-discussed master 110 in FIG. 1) may be selected.

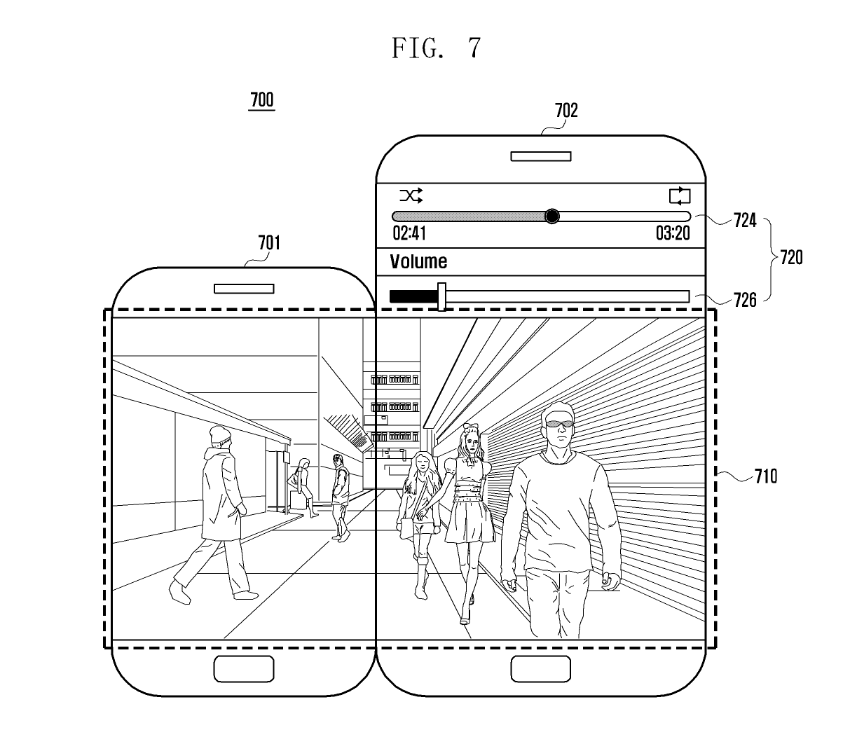

FIG. 7 is a schematic diagram illustrating another example of displaying a control interface of content on at least some electronic devices in a content presenting system according to an embodiment of the present disclosure.

In various embodiments of the present disclosure, the content presenting system 700 of FIG. 7 may be the content presenting system 100 or 200 discussed above.

Referring FIG. 7, the content presenting system 700 may include a first electronic device 701 and a second electronic device 702. Both electronic devices 701 and 702 may operate in a multi-vision mode. Display panels of the electronic devices 701 and 702 may be different in screen size from each other.

In case the electronic devices 701 and 702 having different-sized display panels constitute a single multi-vision group and present given content 710, the electronic device (e.g., the second electronic device 702) having a relatively greater display panel leaves an extra space on the screen. This space may be used to display the control interface 720.

According to various embodiments, the control interface 720 may contain therein at least one of a volume adjusting bar 724, a progressive bar 726, a playable content list (not shown), and control buttons (not shown) corresponding to display control commands (e.g., a play, a seek, a pause, a stop, etc.).

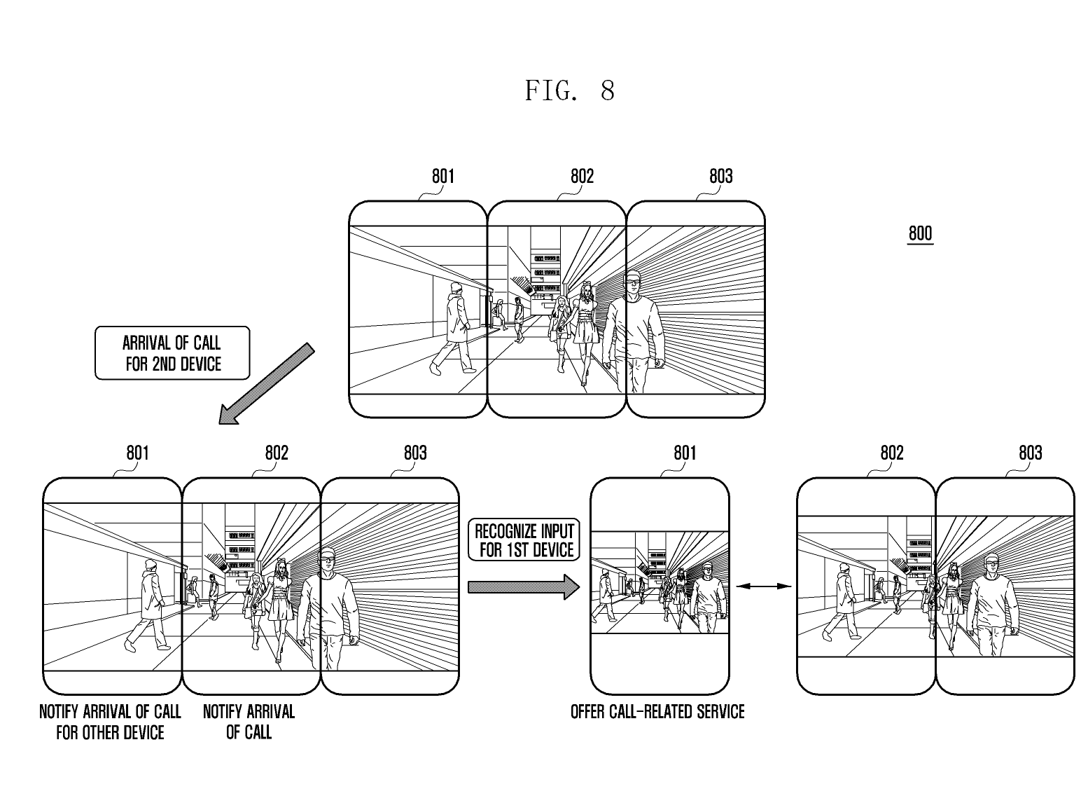

FIG. 8 is a schematic diagram illustrating an example of providing a specific service corresponding to a notification event through any other electronic device when the notification event happens at one of electronic devices in a content presenting system according to an embodiment of the present disclosure.

In various embodiments of the present disclosure, the content presenting system 800 of FIG. 8 may be the content presenting system 100 or 200 discussed above.

Referring FIG. 8, the content presenting system 800 may include a first electronic device 801, a second electronic device 802, and a third electronic device 803. All the electronic devices 801, 802 and 803 may operate in a multi-vision mode.

According to various embodiments, if any notification event (e.g., the arrival of an incoming call) happens at one (e.g., the second electronic device 802) of the electronic devices in the content presenting system 800, this notification event may be forwarded to another predefined electronic device (e.g., the first electronic device 801) such that this electronic device can display the forwarded notification event.

Based on a user input to the electronic device (e.g., the first electronic device 801) that displays the notification event, this electronic device may execute a particular application corresponding to the notification event and thus offer a corresponding service.

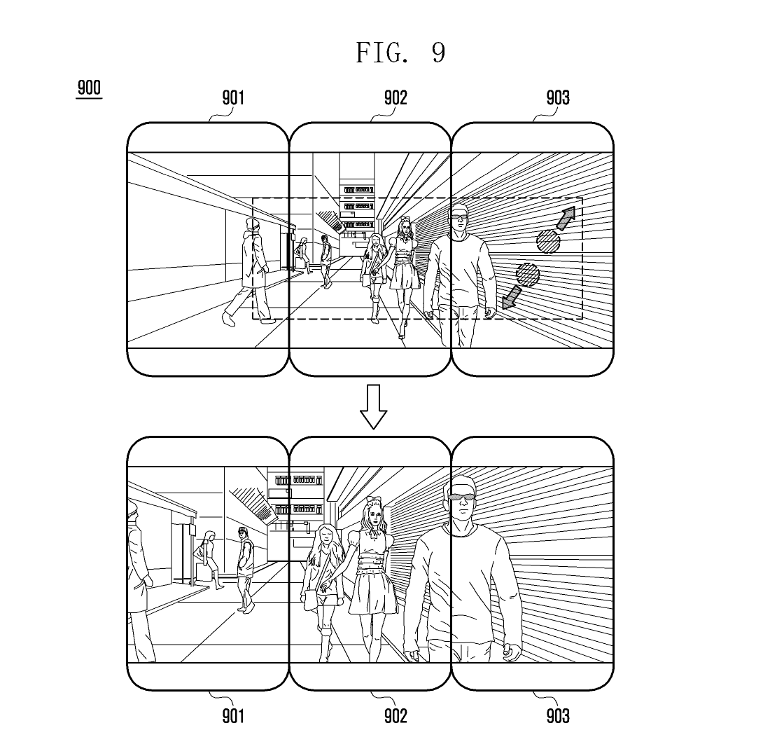

FIG. 9 is a schematic diagram illustrating an example of adjusting content correspondingly at respective electronic devices in response to a user input entered in at least some of the electronic devices in a content presenting system according to an embodiment of the present disclosure.

In various embodiments of the present disclosure, the content presenting system 900 of FIG. 9 may be the content presenting system 100 or 200 discussed above.

Referring FIG. 9, the content presenting system 900 may include a first electronic device 901, a second electronic device 902, and a third electronic device 903. All the electronic devices 901, 902 and 903 may operate in a multi-vision mode.

According to various embodiments, one (e.g., the third electronic device 903) of the electronic devices in the content presenting system 900 may receive a user input (e.g., a pinch-zooming input) for enlarging or reducing the entire content. At this time, the content presenting system 900 may recognize coordinate values of the received user input and a variation thereof. Based on the recognized (e.g., detected) variation of coordinate values, the content presenting system 900 may determine the rate of enlarging or reducing the content displayed on the input-received electronic device (e.g., the third electronic device 903). Also, based on the recognized (e.g., detected) coordinate values and the determined rate, the content presenting system 900 may determine an enlarged or reduced portion of content to be displayed on the input-received electronic device (e.g., the third electronic device 903). Further, based on the determined enlarged or reduced portion, the content presenting system 900 may determine another enlarged or reduced portion of content to be displayed on the other electronic devices (e.g., the first and second electronic devices 901 and 902).

FIG. 10 is a block diagram illustrating an electronic device for presenting content according to an embodiment of the present disclosure.

In various embodiments of the present disclosure, the electronic device 1000 of FIG. 10 may be one of the master electronic device 110 and the first to third slave electronic devices 120, 130 and 140 as shown in FIG. 1, or one of the electronic devices 210, 220, 230 and 240 as shown in FIG. 2.

Referring to FIG. 10, the electronic device 1000 may include an input module 1030, a communication module 1040, a display module 1050, and a content display control module 1060. In case the electronic device 1000 is an electronic device (e.g., the master 110 in FIG. 1) that is defined to perform a function of master, a multi-vision module 1010 and a content providing module 1020 may be further included.

The multi-vision module 1010 may store, modify or manage an electronic device list of the content presenting system including therein the electronic device 1000. Based on an input to at least one of the electronic devices that belong to the content presenting system including therein the electronic device 1000, the multi-vision module 1010 may determine or toggle the operating mode (e.g., a multi-vision mode or a single-vision mode) of each electronic device. Also, based on this operating mode of each electronic device, the multi-vision module 1010 may set or adjust the location of each electronic device. In case there are two or more multi-vision groups in the content presenting system, the multi-vision module 1010 may set or adjust multi-vision group information.

Additionally, the multi-vision module 1010 may create control information corresponding to each electronic device of the content presenting system including therein the electronic device 1000. According to various embodiments, based on the location of specific electronic devices the operating mode of which is a multi-vision mode, the multi-vision module 1010 may set audio channel information of such an electronic device and determine a content portion (i.e., a divided display size) corresponding to each electronic device.

According to various embodiments, the multi-vision module 1010 may create presentation setting information (e.g., brightness, playback speed, volume, etc.) to be applied to the electronic devices of the content presenting system. For example, the multi-vision module 1010 may use presentation setting information applied to the electronic device 1000 so as to create presentation setting information to be applied to the other electronic devices in the content presenting system. Namely, based on such presentation setting information, the other electronic devices may present given content with the same setting as that of the electronic device 1000. This is, however, exemplary only. Alternatively, depending on a content type, a relative location of each electronic device, a display screen size of each electronic device, a battery status of each electronic device, or the like, the multi-vision module 1010 may variously create presentation setting information to be applied individually to each electronic device.

According to various embodiments, the multi-vision module 1010 may create synchronization information to be applied to the electronic devices in the content presenting system. For example, the multi-vision module 1010 may revise synchronization information (e.g., a video playback time, a player engine time, an audio time, a system time, etc.) of the electronic device 1000 to be adapted to the other electronic devices and transmit it to each electronic device.

The content providing module 1020 is a module configured to provide content, stored in the electronic device 1000 or in a storage unit functionally connected to the electronic device 1000, to another electronic device. According to various embodiments, the content providing module 1020 may be formed of an HTTP server module which is accessible to other electronic devices. In this case, the content providing module 1020 may establish a TCP/IP connection with other electronic devices to reliably provide content.

The input module 1030 may transmit a user input (e.g., a shake, a drag, etc.), entered through an input sensor (e.g., a touch sensor, a gesture sensor, a hovering sensor, a voice sensor, etc.) functionally connected to the electronic device 1000, to the multi-vision module 1010 located in the electronic device 1000 or any other electronic device. For example, if the electronic device 1000 is a master electronic device (e.g., the master 110 in FIG. 1) that is defined to perform a function of master in the content presenting system, the electronic device 1000 may transmit a user input to the multi-vision module 1010 located therein. In contrast, if the electronic device 1000 is a slave electronic device (e.g., one of the slaves 120, 130 and 140 in FIG. 1) that is defined to perform a function of slave in the content presenting system, the electronic device 1000 may transmit a user input to the multi-vision module 1010 located in at least one (e.g., the master 110 in FIG. 1) of the other electronic devices through the communication module 1040 to be discussed below.

Additionally, using a user input, the input module 1030 may recognize a distance or relative location between the electronic device 1000 and the others. For example, the input module 1030 may employ any additional sensor (e.g., a proximity sensor, a grip sensor, an NFC sensor, etc.) for recognizing such a distance or relative location. Alternatively, the input module 1030 may measure such a distance or relative location during a communication process between the electronic device 1000 and the others.

The communication module 1040 may establish a connection between the electronic device 1000 and at least some of the other electronic devices. Through this connection, the communication module 1040 may transmit or receive at least some information (e.g., an electronic device list of a content presenting system, an operating mode of each electronic device, audio channel information, content portion information, presentation setting information, synchronization information, etc.), created by the multi-vision module 1010 located in the electronic device 1000 or at least one of the other electronic devices, to or from at least one of the other electronic devices.

The display module 1050 may present given content through a display screen functionally connected to the electronic device 1000. According to various embodiments, if the electronic device 1000 is a master electronic device (e.g., the master 110 in FIG. 1) that is defined to perform a function of master in the content presenting system, the display module 1050 may present given content stored in the electronic device 1000 or in a storage unit functionally connected to the electronic device 1000. According to another embodiment, if the electronic device 1000 is a slave electronic device (e.g., one of the slaves 120, 130 and 140 in FIG. 1) that is defined to perform a function of slave in the content presenting system, the display module 1050 may receive content from any external content providing module 1020.

The content display control module 1060 may control the display module 1050 such that the electronic device 1000 may operate in a multi-vision mode or a single-vision mode on the basis of the operating mode of the electronic device 1000. The content display control module 1060 may control a content display through the display module 1050, based on information (e.g., an electronic device list of a content presenting system, an operating mode of each electronic device, audio channel information, content portion information, presentation setting information, synchronization information, etc.) created by the multi-vision module 1010 located in the electronic device 1000 or in at least one of the other electronic devices.

According to various embodiments, the content display control module 1060 may determine the electronic device 1000 as a master or a slave in the content presenting system, depending on a user input. In case the electronic device 1000 is determined as a master, the content display control module 1060 may create the multi-vision module 1010 and the content providing module 1020 in the electronic device 1000 such that the electronic device 1000 may operate as a master.

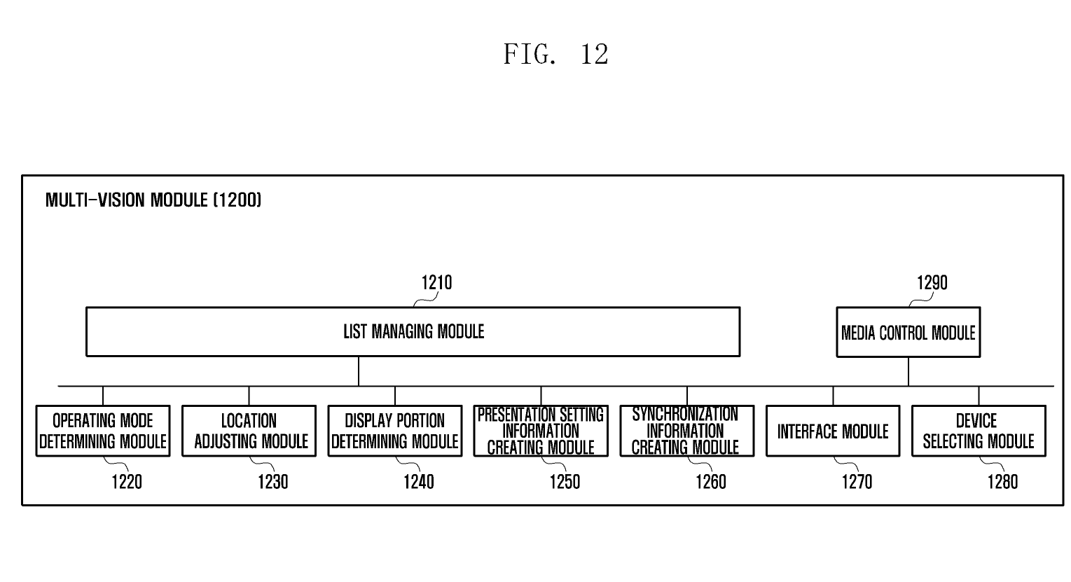

According to various embodiments, if the electronic device 1000 is a slave device (e.g., one of the slaves 120, 130 and 140 in FIG. 1) that is defined to perform a function of slave in the content presenting system, the content display control module 1060 may create some sub-modules (e.g., a synchronization information creating module 1260 in FIG. 12) of the multi-vision module 1010 in the electronic device 1000 by receiving instructions from another electronic device (e.g., the master 110 in FIG. 1) that is defined to perform a function of master in the content presenting system.

FIG. 11 is a block diagram illustrating a master electronic device and a slave electronic device in a content presenting system according to an embodiment of the present disclosure.

In various embodiments of the present disclosure, the content presenting system 1100 of FIG. 11 may be, for example, the content presenting system 100 discussed above and shown in FIG. 1 or the content presenting system 200 discussed above and shown in FIG. 2.

Referring to FIG. 11, the content presenting system 1100 may include a master 1110 electronic device and a slave 1120 electronic device.

The master 1110 electronic device includes a display module 1111, a content providing module 1112, an input module 1113, a multi-vision module 1114, a content display control module 1115, and a communication module 1116. For example, the master electronic device 1110 may be the master 110 shown in FIG. 1 or the electronic device 1000 shown in FIG. 10.

The display module 1111 may display (e.g., playback) content stored in a storage unit (not shown) functionally connected to the master electronic device 1110.

The content providing module 1112 may provide specific content, to be displayed through the display module 1111, to any external electronic device (e.g., the slave electronic device 1120). According to various embodiments, the content providing module 1112 may create link information that allows another electronic device (e.g., the slave electronic device 1120) to access specific content. For example, the content providing module 1112 may be formed of an HTTP server.

The input module 1113 may receive the first user input (e.g., a drag or a shake) for toggling the operating mode of the master electronic device 1110 through an input unit (not shown) or a sensor (not shown) functionally connected to the master electronic device 1110.

The multi-vision module 1114 may determine or change the operating mode and location information of the master electronic device 1110 or another electronic device (e.g., the slave electronic device 1120), based on the first user input received through the input module 1113 or the second user input for toggling the operating mode of another electronic device (e.g., the slave electronic device 1120).

The multi-vision module 1114 may set content portion information and audio channel setting information corresponding to the master electronic device 1110 or another electronic device (e.g., the slave electronic device 1120), based on the operating mode and location information of the master electronic device 1110 or another electronic device (e.g., the slave electronic device 1120). Also, based on presentation setting information of at least one of the master electronic device 1110 and another electronic device (e.g., the slave electronic device 1120), the multi-vision module 1114 may determine presentation setting information of another electronic device. Further, based on synchronization information of the master electronic device 1110, the multi-vision module 1114 may create synchronization information of another electronic device (e.g., the slave electronic device 1120).

The content display control module 1115 may control the display module 1111 on the basis of the operating mode, location information, content portion information, audio channel setting information, presentation setting information, etc. of the master electronic device 1110 such that the display module 1111 can display given content in an operating mode (e.g., a multi-vision mode or a single-vision mode) corresponding to the first user input.

The communication module 1116 may transmit, to another electronic device (e.g., the slave electronic device 1120), the operating mode, location information, content portion information, audio channel setting information, presentation setting information, synchronization information, content link information, etc. of that electronic device (e.g., the slave electronic device 1120). According to various embodiments, the content link information may be defined to be obtained from the content providing module 1112 at the multi-vision module 1114 and to be transmitted to the communication module 1116. According to another embodiment, the content link information may be defined to be transmitted to the communication module 1116 at the content providing module 1112.

The communication module 1116 may receive the second user input for toggling the operating mode of another electronic device (e.g., the slave electronic device 1120) from that electronic device (e.g., the slave electronic device 1120) and transmit it to the multi-vision module 1114. According to various embodiments, the communication module 1116 may further receive presentation setting information (e.g., brightness, playback speed, volume, etc.) about content displayed on another electronic device (e.g., the slave electronic device 1120) and transmit it to the multi-vision module 1114.

The slave electronic device 1120 includes an input module 1121, a communication module 1122, a content display control module 1123, and a display module 1124. For example, the slave electronic device 1120 may be one of the slave electronic devices 120, 130 and 140 shown in FIG. 1 or the electronic device 1000 shown in FIG. 10.

The input module 1121 may receive the second user input (e.g., a drag or a shake) for toggling the operating mode of the slave electronic device 1120.

The communication module 1122 may transmit the second user input for toggling the operating mode of the slave electronic device 1120 to the master electronic device 1110. Additionally, the communication module 1122 may receive, from the master electronic device 1110, the operating mode, location information, content portion information, audio channel setting information, presentation setting information, synchronization information, content link information, etc. of the slave electronic device 1120. According to various embodiments, the communication module 1122 may further transmit presentation setting information (e.g., brightness, playback speed, volume, etc.) about content displayed on the display module 1124 to the master electronic device 1110.

The content display control module 1123 may offer, to the display module 1124, the content link information received through the communication module 1122, and also control the display module 1124 on the basis of the operating mode, location information, content portion information, audio channel setting information, presentation setting information, etc. received through the communication module 1122.

The display module 1124 receives content, based on the content link information. Also, under the control of the content display control module 1123, the display module 1124 may display the received content in an operating mode (e.g., a multi-vision mode or a single-vision mode) corresponding to the second user input.

FIG. 12 is a block diagram illustrating a multi-vision module of an electronic device according to an embodiment of the present disclosure.

In various embodiments of the present disclosure, the multi-vision module 1200 of FIG. 12 may be, for example, the multi-vision module 1010 discussed above and shown in FIG. 10 or the multi-vision module 1114 discussed above and shown in FIG. 11.

Referring to FIG. 12, the multi-vision module 1200 may include a list managing module 1210, an operating mode determining module 1220, a location adjusting module 1230, a display portion determining module 1240, a presentation setting information creating module 1250, a synchronization information creating module 1260, an interface module 1270, an electronic device selecting module 1280, and a media control module 1290.

The list managing module 1210 may store and manage an electronic device list of the content presenting system. For example, while given content is presented simultaneously through a plurality of electronic devices in the content presenting system, the list managing module 1210 may manage, using the electronic device list, information about the electronic devices that present the content. If any electronic device is added to or removed from the content presenting system in response to a user input, the list managing module 1210 may add or remove information about such an electronic device to or from the electronic device list.

The operating mode determining module 1220 may determine the operating mode of at least one of a plurality of electronic devices in the content presenting system, based on an input (e.g., a shake, a drag, etc.) for the electronic device(s). According to various embodiments, if a shake input is recognized (e.g., detected) for one of the electronic devices, the operating mode of the input-recognized electronic device may be determined as a single-vision mode. Even though the operating mode of that electronic device has been already set to a multi-vision mode, the operating mode may be changed from a multi-vision mode to a single-vision mode. According to another embodiment, if a drag input is recognized (e.g., detected) for two or more electronic devices, the operating mode of the input-recognized (e.g., detected) electronic devices may be determined as a multi-vision mode. For example, if there are three electronic devices corresponding to a drag input, if the drag input has a direction from the leftmost electronic device to the rightmost electronic device, if the operating mode of the rightmost electronic device among three electronic devices is a multi-vision mode, and if the operating mode of the others is a single-vision mode, the operating mode of the others may be changed from a single-vision mode to a multi-vision mode.

The location adjusting module 1230 may adjust the location of each electronic device in the content presenting system, based on the operating mode determined by the operating mode determining module 1220. According to various embodiments, in case the operating mode of a certain electronic device is toggled to a single-vision mode by the operating mode determining module 1220, the location adjusting module 1230 may change a location value corresponding to the location information of that electronic device to “−1” and also adjust the location information of the other electronic devices.

According to another embodiment, in case the operating mode of a certain electronic device is toggled from a single-vision mode to a multi-vision mode by the operating mode determining module 1220, the location adjusting module 1230 may analyze a user input (e.g., a drag on two or more electronic devices) corresponding to such toggling and thereby determine a location value of the mode-toggled electronic device. For example, a location value of an electronic device the operating mode of which is toggled from a single-vision mode to a multi-vision mode may be determined as a location value of another electronic device which has already operated in a multi-vision mode and now increases or decreases a location value in response to a user input (e.g., a drag direction).

The display portion determining module 1240 may set audio channel information about each multi-vision electronic device the operating mode of which is set to a multi-vision mode, and divide given content into content portions corresponding to respective multi-vision electronic devices, based on the location of such multi-vision electronic devices among a plurality of electronic devices in the content presenting system.

According to various embodiments, in order to output an audio part of content at two channels, the display portion determining module 1240 may set audio channel information corresponding to two electronic devices (e.g., an electronic device having the location value “1” and an electronic device having the greatest location value) located at both ends of multi-vision electronic devices.

According to various embodiments, in order to divide a video part of content into portions adapted for respective multi-vision electronic devices, the display portion determining module 1240 may define content portions corresponding to respective multi-vision electronic devices, based on both the ratio of a display size of each multi-vision electronic device to the total display size of all multi-vision electronic devices and the location information of each multi-vision electronic device. For example, in case all the multi-vision electronic devices have the same display size, the display portion determining module 1240 may equally divide a video part of content into same-sized video playback portions the number of which is equal to that of the multi-vision electronic devices, and apply the video playback portions as content portions to the respective multi-vision electronic devices on the basis of the location information of each multi-vision electronic device. Such video playback portions may be parts of the entire video playback screen. Each video playback portion may be specified by means of at least one of coordinates thereof and a size (width or height) thereof.

The presentation setting information creating module 1250 may determine presentation setting information (e.g., brightness, playback speed, volume, etc.) of a plurality of electronic devices in the content presenting system. According to various embodiments, the presentation setting information of multi-vision electronic devices the operating mode of which is set to a multi-vision mode may be equally defined. For example, the presentation setting information of electronic devices may be the same as that of a specific electronic device (e.g., the master electronic device 1110 in FIG. 11) where the multi-vision module is located.

The synchronization information creating module 1260 may create synchronization information which is used as synchronization criteria of a plurality of electronic devices in the content presenting system such that the electronic devices can be synchronized with each other and thereby present given content. According to various embodiments, the synchronization information creating module 1260 may create synchronization information from current time information (e.g., a video playback clock (time stamp) and/or an audio playback clock (time stamp) of content currently playing in the display module, a reference clock (time stamp) of the display module, a system clock (time stamp) of an electronic device having the display module, etc.) associated with content presentation of the electronic device (e.g., the master electronic device 1110 in FIG. 11) having the multi-vision module. The electronic devices may compensate any delay caused by transmission of such synchronization information and, based on the compensated synchronization information, present given content.

The interface module 1270 may transmit any information created at another element of the multi-vision module 1200, for example, the operating mode determining module 1220, the location adjusting module 1230, the display portion determining module 1240, or the presentation setting information creating module 1250, to the outside of the multi-vision module 1200.

According to various embodiments, the interface module 1270 may transmit audio channel information, content portion information, presentation setting information, etc., which are set to correspond to a specific electronic device (e.g., the master electronic device 1110 in FIG. 11) having the multi-vision module among a plurality of electronic devices, to the content display control module functionally connected to the multi-vision module or contained in the electronic device having the multi-vision module. Also, the interface module 1270 may transmit operating mode information, location information, audio channel information, content portion information, presentation setting information, etc., which correspond to each of the other electronic devices, to such electronic devices through the communication module functionally connected to the multi-vision module or contained in the electronic device having the multi-vision module. Additionally, the interface module 1270 may transmit link information (e.g., URL) about content, to be presented at the other electronic devices, to such electronic devices.

The electronic device selecting module 1280 may select at least one electronic device (or a group containing at least one electronic device) among electronic devices that belong to a multi-vision group, based on information about such an electronic device or a user input for such an electronic device. According to various embodiments, at least one electronic device selected by the electronic device selecting module 1280 may perform a particular function associated with content presentation. For example, at least one electronic device selected by the device selecting module 1280 may operate as at least one of a control interface, an audio output device, and a notification service provider.

The media control module 1290 may receive display control commands (e.g., a play, a seek, a pause, a stop, etc.) regarding content from a user through a control interface functionally connected to at least one of electronic devices in the content presenting system, and create display control signals corresponding to the received control commands. Through the interface module 1270, the media control module 1290 may transmit such display control signals to the electronic device (e.g., the master electronic device 1110 in FIG. 11) having the multi-vision module and to the other electronic devices.

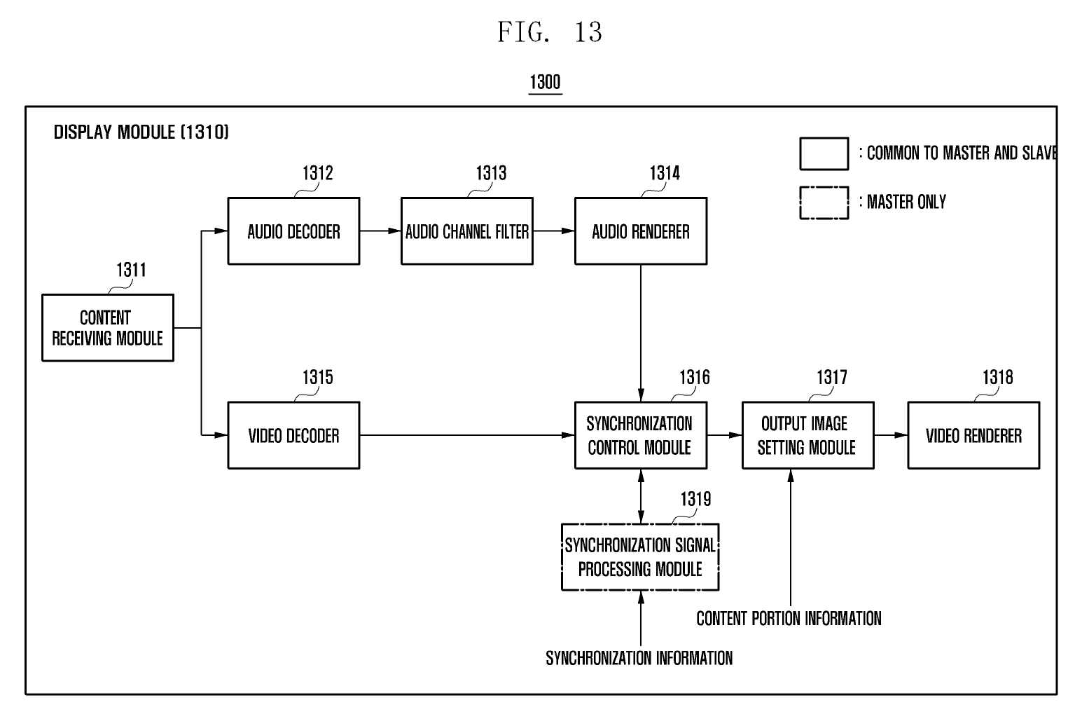

FIG. 13 is a block diagram illustrating a display module of an electronic device according to an embodiment of the present disclosure.

In various embodiments of the present disclosure, the electronic device 1300 of FIG. 13 is, for example, the electronic device 1000 discussed above and shown in FIG. 10 or one of the master electronic device 1110 and the slave electronic device 1120 discussed above and shown in FIG. 11.

Referring to FIG. 13, the electronic device 1300 may include a display module 1310 (e.g., 1040 in FIG. 10, 1111 or 1124 in FIG. 11). The display module 1310 may include a content receiving module 1311, an audio decoder 1312, an audio channel filter 1313, an audio renderer 1314, a video decoder 1315, a synchronization control module 1316, an output image setting module 1317, and a video renderer 1318.

The content receiving module 1311 may receive content signals, encoded for transmission of content, from a storage unit functionally connected thereto or from any external content providing server (e.g., the content providing module 1020 in FIG. 10).

The audio decoder 1312 may extract audio signals from the content signals received by the content receiving module 1311. The audio decoder 1312 may obtain audio channel setting information (e.g., PCM data) of content by decoding the extracted audio signals. In these embodiments, the audio channel setting information may include, for example, audio output information corresponding to the respective electronic devices in the content presenting system (e.g., the content presenting system 100 in FIG. 1).

The audio channel filter 1313 may obtain the audio output information corresponding to the electronic device 1300 from the audio channel setting information (e.g., PCM data) of content.

The audio renderer 1314 may output audio through an audio output unit (e.g., a speaker or an earphone) functionally connected to the display module 1310, based on the audio output information of the electronic device 1300 obtained by the audio channel filter 1313.

The video decoder 1315 extracts video signals from the content signals received by the content receiving module 1311. The video decoder 1315 may obtain video original data (e.g., RGB data) by decoding the extracted video signals.

The synchronization control module 1316 may obtain an audio clock of the audio output information from the audio renderer 1314 for synchronization between audio and video and adjust a video clock of the video original data to coincide with the obtained audio clock.

The output image setting module 1317 may obtain partial video original data corresponding to the electronic device 1300 from among the video original data, based on the content portion information corresponding to the electronic device 1300.

The video renderer 1318 may output video through a video display unit (e.g., a display panel) functionally connected to the display module 1310, based on the partial video original data.

The display module 1310 may further include a synchronization signal processing module 1319 in case the electronic device 1300 is a slave (e.g., slave electronic device 1120 in FIG. 11). The synchronization signal processing module 1319 may compensate the synchronization information of a master (e.g., master electronic device 1110 in FIG. 11) received from the master so as to synchronize the master with the electronic device 1300 which is the slave (e.g., slave electronic device 1120 in FIG. 11). The synchronization information of the master may include, for example, at least one of a video playback clock of the master, an audio playback clock of the master, and a reference clock of the display module.

According to various embodiments, the synchronization signal processing module 1319 may compensate the synchronization information of the master, considering a delay due to arrival at the synchronization signal processing module 1319. For example, the synchronization signal processing module 1319 may compensate the synchronization information of the master, based on a system clock of the master, a system clock of the electronic device 1300, and the like.

According to various embodiments, the synchronization signal processing module 1319 transmits the compensated synchronization information of the master to the synchronization control module 1316. An audio clock or a video clock of the synchronization control module 1316 may be adjusted to conform to the synchronization information of the master.

According to various embodiments, the electronic device may include a memory and at least one processor. The memory may be configured to store information about a plurality of electronic devices having the first electronic device and the second electronic device. The processor may be configured to execute a multi-vision module. The multi-vision module may be configured to identify an input for at least one electronic device from among the plurality of electronic devices while given content is presented through the plurality of electronic devices such that the first portion of the content is displayed through the first electronic device and the second portion of the content is displayed through the second electronic device. Based on the input, the multi-vision module may be configured to define the first group including the first electronic device and the second group including the second electronic device from among the plurality of electronic devices. The multi-vision module may be configured to control at least one of the plurality of electronic devices such that the content is presented through the first and second groups independently of each other.

According to various embodiments, the multi-vision module may be further configured to control at least one electronic device such that the content is displayed through the first group and simultaneously displayed through the second group.

According to various embodiments, the electronic devices may include the first electronic device, the second electronic device, or at least one electronic device.

According to various embodiments, each of the first and second groups may include therein a plurality of electronic devices.

According to various embodiments, the multi-vision module may be further configured to identify the above-mentioned input that may include at least one of a user gesture, a user touch, a user voice, and a distance between two or more electronic devices.

According to various embodiments, the multi-vision module may be further configured to further define, based on the input for at least one of the plurality of electronic devices, the third group that contains therein an electronic device of the first group or an electronic device of the second group. The multi-vision module may be further configured to control at least one electronic device such that the content is offered independently through each of the third group and the others.

According to various embodiments, the multi-vision module may be further configured to control at least one electronic device such that the content is divided into portions corresponding to the plurality of electronic devices assigned to at least one of the first and second groups and that each portion is displayed on each electronic device.

According to various embodiments, the multi-vision module may be further configured to control at least one electronic device such that the content is displayed on each of the plurality of electronic devices contained in at least one of the first and second groups.

According to various embodiments, the content may include a plurality of contents including the first content and the second content. The multi-vision module may be further configured to control at least one electronic device such that the first content is displayed through the first group and the second content is displayed through the second group.

According to various embodiments, the content may include multimedia content. The multi-vision module may be further configured to control at least one electronic device such that data corresponding to the first display portion of the multimedia content is displayed through the first group and, at the same time, data corresponding to the second display portion of the multimedia content is displayed through the second group.

According to various embodiments, the electronic device may include a memory and at least one processor. The memory may be configured to store information about a plurality of electronic devices having the first electronic device and the second electronic device. The processor may be configured to execute a multi-vision module. The multi-vision module may be configured to select at least one electronic device from among the plurality of electronic devices, based on at least one of information about the plurality of electronic devices and a user input for at least one of the electronic devices. The multi-vision module may be configured to present given content through the plurality of electronic devices such that the first portion of the content is displayed through the first electronic device and the second portion of the content is displayed through the second electronic device. Also, the multi-vision module may be configured to control one or more electronic devices among the electronic devices such that a particular function associated with presentation of the content is performed through the selected at least one electronic device.

According to various embodiments, the multi-vision module may be further configured to control the one or more electronic devices such that the particular function is performed together with the presenting of the content.

According to various embodiments, the multi-vision module may be further configured to control the one or more electronic devices such that an interface is presented to recognize a user's control input corresponding to playback of the content through at least part of a display region of the selected electronic device.

According to various embodiments, the multi-vision module may be further configured to control the one or more electronic devices such that audio of the content is outputted through the selected electronic device.

According to various embodiments, the multi-vision module may be further configured to control the one or more electronic devices such that text of the content is displayed through at least part of the display region of the selected electronic device.

According to various embodiments, the multi-vision module may be further configured to allow a particular application corresponding to a notification event, occurring at another electronic device, to be executed through the selected electronic device.

According to various embodiments, the electronic device may include a memory and at least one processor. The memory may be configured to store information about a plurality of electronic devices having the first electronic device and the second electronic device. The processor may be configured to execute a multi-vision module. The multi-vision module may be configured to identify an input for at least one electronic device from among the plurality of electronic devices while given content is presented through the plurality of electronic devices such that the first portion of the content is displayed through the first electronic device and the second portion of the content is displayed through the second electronic device. Based on the input, the multi-vision module may be configured to adjust at least one of the first and second portions and to control at least one of the electronic devices such that the first and second portions are displayed through the first and second electronic devices, respectively.

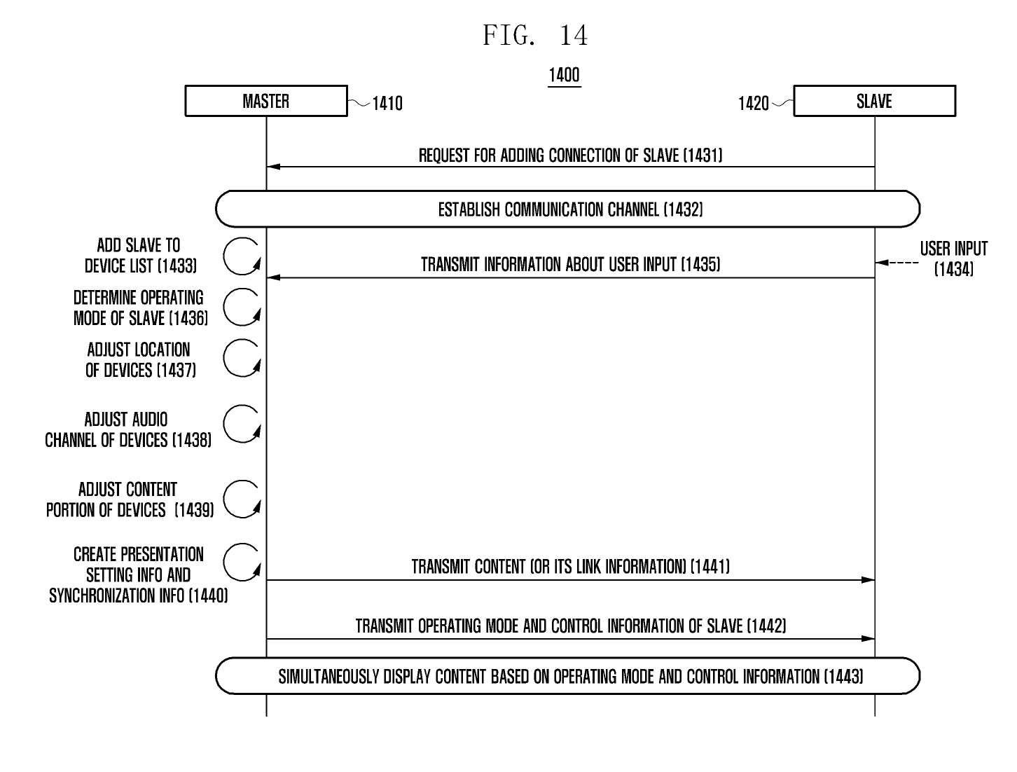

FIG. 14 is a flow diagram illustrating a process of adding a connection with a slave electronic device in a content presenting system according to an embodiment of the present disclosure.

In various embodiments of the present disclosure, the content presenting system 1400 of FIG. 14 may include, for example, a master electronic device 1410 and one or more other slave electronic devices (not shown). Additionally, the content presenting system 1400 may be the content presenting system 1100 shown in FIG. 11. For example, the master electronic device 1410 in the content presenting system 1400 may be the master electronic device 1110 shown in FIG. 11 or the master 1200 shown in FIG. 12, and the slave electronic device 1420 may be the slave electronic device 1120 shown in FIG. 11.

Referring to FIG. 14, at operation 1431, a communication module (e.g., 1122 in FIG. 11) of the slave electronic device 1420 may transmit, to the master electronic device 1410, a request for adding a connection of a slave electronic device. This request may contain therein information (e.g., resolution, Display Pixel Inch (DPI), information for forming a communication channel, etc.) about such a slave electronic device.

At operation 1432, to simultaneously present given content, a communication module (e.g., 1116 in FIG. 11) of the master 1410 electronic device and the communication module (e.g., 1122 in FIG. 11) of the slave 1420 electronic device may establish a communication channel for the exchange of control information between the master 1410 electronic device and the slave 1420 electronic device. This communication channel between the master 1410 electronic device and the slave 1420 electronic device may comply with various standards such as WiFi-Direct, Bluetooth, NFC, DTD, 3G/4G/LTE network, or the like, being not limited to any specific communication protocol. According to various embodiments, in case the master 1410 electronic device and the slave 1420 electronic device are connected to each other through WiFi-Direct, the master 1410 electronic device may try a socket connection with the slave 1420 electronic device. If such a socket connection is made successfully, the master 1410 electronic device may transmit various types of control information to the slave 1420 electronic device through a socket.

At operation 1433, a list managing module (e.g., 1210 in FIG. 12) of the master electronic device 1410 may add information about the slave electronic device 1420 to an electronic device list of the content presenting system 1400.

At operation 1434, an input module (e.g., 1113 in FIG. 11) of the slave electronic device 1420 may recognize a user input (e.g., a drag) for toggling to a multi-vision mode.

At operation 1435, the communication module (e.g., 1122 in FIG. 11) of the slave electronic device 1420 may transmit information (e.g., recognition time, direction, etc.) about the user input to the master electronic device 1410.

At operation 1436, an operating mode determining module (e.g., 1220 in FIG. 12) of the master electronic device 1410 may determine the operating mode of the slave electronic device 1420, based on the information about the user input recognized (e.g., detected) by the slave electronic device 1420.

At operation 1437, if the operating mode of the slave electronic device 1420 is determined as a multi-vision mode, a location adjusting module (e.g., 1230 in FIG. 12) of the master electronic device 1410 may set the location information of the slave electronic device 1420 and also adjust the location of at least parts of the other multi-vision mode electronic devices, based on user input information.

At operation 1438, if the operating mode of the slave electronic device 1420 is determined as a multi-vision mode, a display portion determining module (e.g., 1240 in FIG. 12) of the master electronic device 1410 may set the audio channel information of the slave electronic device 1420 and also adjust the audio channel information of the other multi-vision mode electronic devices, based on the location information of the slave electronic device 1420.

At operation 1439, if the operating mode of the slave electronic device 1420 is determined as a multi-vision mode, the display portion determining module (e.g., 1240 in FIG. 12) of the master electronic device 1410 may set a content portion of the slave electronic device 1420 and also adjust content portions of the other multi-vision mode electronic devices, based on the location information of the slave electronic device 1420.

At operation 1440, a presentation setting information creating module (e.g., 1250 in FIG. 12) and a synchronization information creating module (e.g., 1260 in FIG. 12) of the master electronic device 1410 may create the presentation setting information (e.g., brightness, playback speed, volume, etc.) and the synchronization information, respectively, to be applied to the presentation of content at the slave electronic device 1420.

At operation 1441, the communication module (1116 in FIG. 11) or a content providing module (e.g., 1112 in FIG. 11) of the master electronic device 1410 may transmit content (or link information thereof) to the slave electronic device 1420.

At operation 1442, the communication module (1116 in FIG. 11) of the master electronic device 1410 may transmit, to the slave electronic device 1420, the operating mode and the control information (e.g., audio channel information, content portion information, presentation setting information, synchronization information, etc.) both of which correspond to the slave electronic device 1420. The content (or link information thereof) at operation 1441 and the operating mode and the control information at operation 1442 may be transmitted through the same communication channel or transmitted independently of each other through different communication channels. According to various embodiments, in case the master electronic device 1410 and the slave electronic device 1420 are connected to each other through WiFi-Direct, the first socket session for transmission of content (or link information thereof) and the second socket session for transmission of operating mode and control information may be separately established. At operation 1443, the master electronic device 1410 and the slave electronic device simultaneously display content based on the operating mode and control information transmitted and received at operation 1442.

Additionally, in case the operating mode of the newly added slave electronic device 1420 is determined as a single-vision mode, at least parts (e.g., operations 1437, 1438 and 1439) of operations shown in FIG. 14 may be skipped.

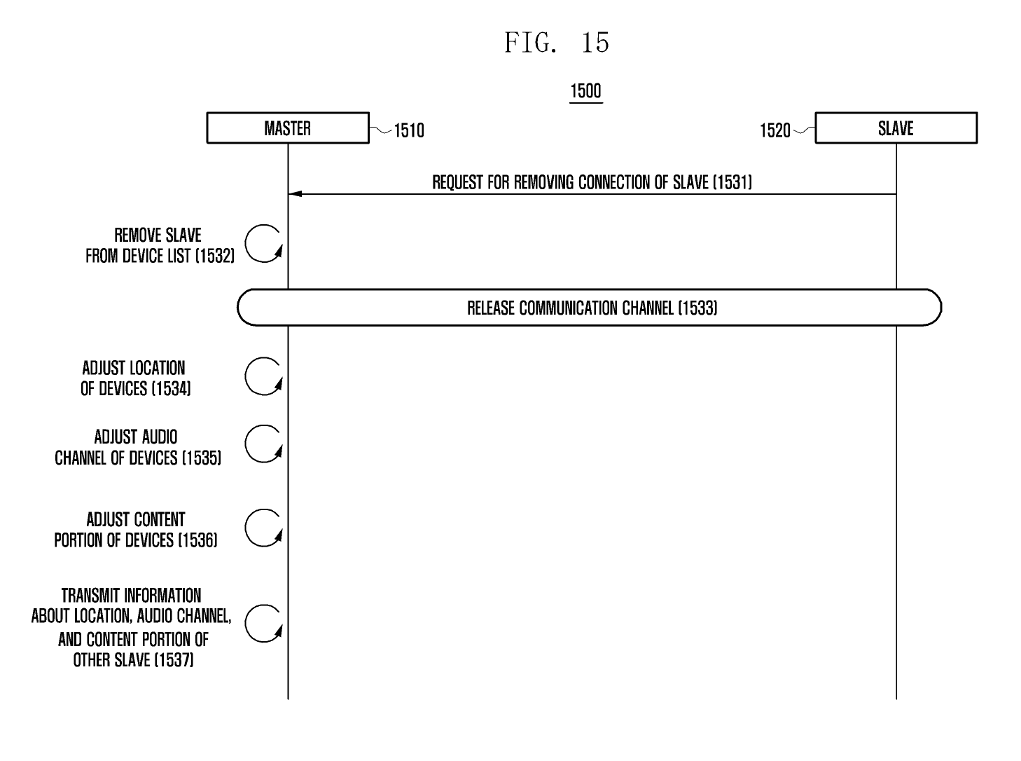

FIG. 15 is a flow diagram illustrating a process of removing a connection with a slave electronic device in a content presenting system according to an embodiment of the present disclosure.

In various embodiments of the present disclosure, the content presenting system 1500 of FIG. 15 may include, for example, a master electronic device 1510 and one or more other slave electronic devices (not shown) in addition to the slave electronic device 1520. Additionally, the content presenting system 1500 may be the content presenting system 1100 shown in FIG. 11. For example, the master electronic device 1510 may be the master electronic device 1110 shown in FIG. 11 or the master 1200 electronic device shown in FIG. 12, and the slave electronic device 1520 may be the slave electronic device 1120 shown in FIG. 11.

Referring to FIG. 15, at operation 1531, a communication module (e.g., 1122 in FIG. 11) of the slave electronic device 1520 may transmit, to the master electronic device 1510, a request for removing a connection of slave.

At operation 1532, a list managing module (e.g., 1210 in FIG. 12) of the master electronic device 1510 may remove information about the slave electronic device 1520 from an electronic device list of the content presenting system 1500.

At operation 1533, the master electronic device 1510 may release a communication channel (e.g., a socket session for transmission of content or link information thereof, or a socket session for transmission of operating mode and control information) with the slave electronic device 1520.

At operation 1534, if the operating mode of the slave electronic device 1520 has been a multi-vision mode, a location adjusting module (e.g., 1230 in FIG. 12) of the master electronic device 1510 may adjust the location of at least parts of the multi-vision mode electronic devices except the slave electronic device 1520, based on user input information.

At operation 1535, if the operating mode of the slave electronic device 1520 has been a multi-vision mode, a display portion determining module (e.g., 1240 in FIG. 12) of the master electronic device 1510 may adjust the audio channel information of the multi-vision mode electronic devices except the slave electronic device 1520, based on the location information of the slave electronic device 1520.

At operation 1536, if the operating mode of the slave electronic device 1520 has been a multi-vision mode, the display portion determining module (e.g., 1240 in FIG. 12) of the master electronic device 1510 may adjust content portions of the multi-vision mode electronic devices except the slave electronic device 1520, based on the location information of the slave electronic device 1520.

At operation 1537, the communication module (1116 in FIG. 11) of the master electronic device 1510 may transmit the location information, audio channel information and content portion information corresponding to another slave electronic device through a communication channel with such a slave electronic device.

Additionally, in case the operating mode of the newly added slave electronic device 1520 has been a single-vision mode, at least parts (e.g., operations 1534, 1535, 1536 and 1537) of operations shown in FIG. 15 may be skipped.

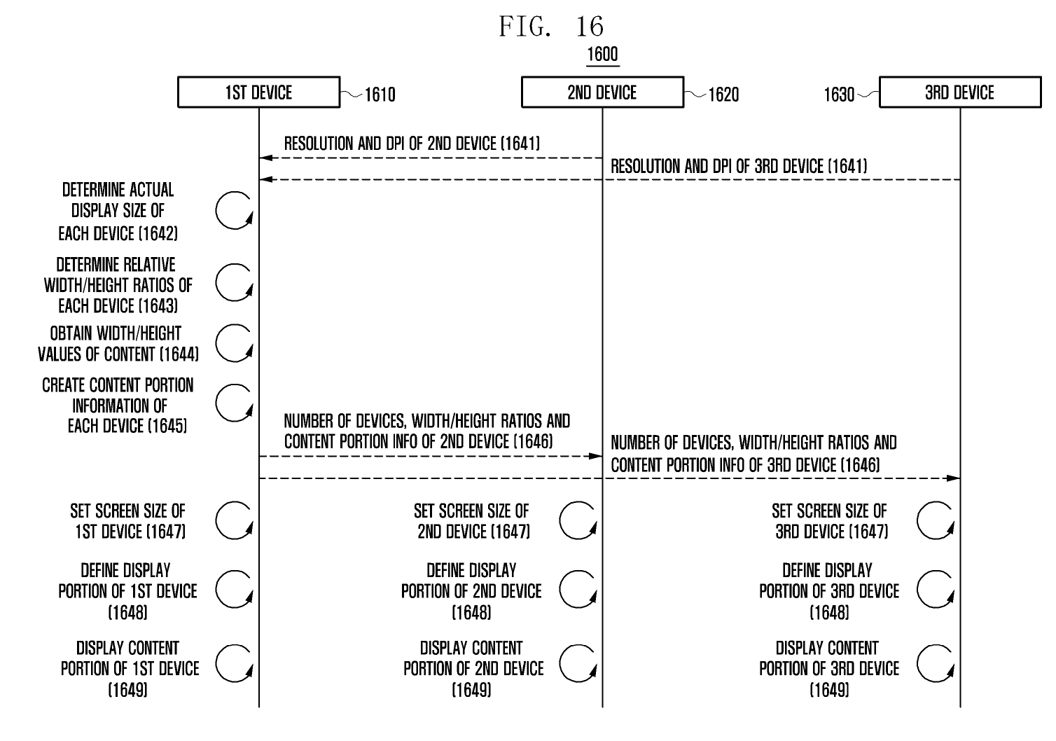

FIG. 16 is a flow diagram illustrating a process of dividing content into portions according to an embodiment of the present disclosure.

In various embodiments of the present disclosure, a content presenting system 1600 in these embodiments may include a first electronic device 1610, a second electronic device 1620, and a third electronic device 1630. For example, the first electronic device 1610 may be the electronic device shown in FIG. 10 or the master electronic device 1110 shown in FIG. 11. For example, each of the second and third electronic devices 1620 and 1630 may be the electronic device shown in FIG. 10 or the slave electronic device 1120 shown in FIG. 11. The first, second and third electronic devices 1610, 1620 and 1630 may be grouped as a single multi-vision group that is set to simultaneously present the same content in a multi-vision mode.

Referring to FIG. 16, a communication module (e.g., 1116 in FIG. 11) of the first electronic device 1610 may collect information, for example, resolution (e.g., 1080P (1920*1080)) and DPI, about the second and third electronic devices 1620 and 1630 which are the other electronic devices in the same multi-vision group at operation 1641. For example, resolution may have a width pixel value (e.g., 1920) and a height pixel value (e.g., 1080). For example, DPI may have a width DPI value and a height DPI value, both of which may be the same value or different values.

In these embodiments, the terms width and height may denote the width and height of a display of the electronic device, respectively.

At operation 1642, a display portion determining module (e.g., 1240 in FIG. 12) of the first electronic device 1610 may determine an actual display size of each electronic device, based on information (e.g., resolution and DPI) about the electronic devices (e.g., the first, second and third electronic devices 1610, 1620 and 1630) in the multi-vision group. An actual width of each electronic device may be determined from dividing a width pixel value (e.g., 1920) of resolution by a width DPI value. Similarly, an actual height of each electronic device may be determined from dividing a height pixel value (e.g., 1080) of resolution by a height DPI value.

At operation 1643, the display portion determining module (e.g., 1240 in FIG. 12) of the first electronic device 1610 may determine a relative width ratio and height ratio of each electronic device that belongs to the multi-vision group. According to various embodiments, a width ratio of the electronic device having the smallest actual width may be set to a certain value (e.g., 1000), and a width ratio of each of the other electronic devices may be determined using the following equation: (the smallest width)*1000/(the width of each electronic device). Similarly, a height ratio of the electronic device having the smallest height may be set to a certain value (e.g., 1000), and a height ratio of each of the other electronic devices may be determined using the following equation: (the smallest height)*1000/(the height of each electronic device).

At operation 1644, the display portion determining module (e.g., 1240 in FIG. 12) of the first electronic device 1610 may obtain width and height values of content from the content to be presented through a multi-vision mode.

At operation 1645, the display portion determining module (e.g., 1240 in FIG. 12) of the first electronic device 1610 may create the content portion information (e.g., a divided size, portion defining information, etc.) corresponding to each electronic device that belongs to the multi-vision group.

According to various embodiments, the display portion determining module (e.g., 1240 in FIG. 12) of the first electronic device 1610 may determine a divided size of each electronic device that belongs to the multi-vision group. A divided width size of each electronic device may be determined using the following equation: (the width of content)*(a width ratio of each electronic device)/(sum of width ratios of all electronic devices). Similarly, a divided height size of each electronic device may be determined using the following equation: (the height of content)*(a height ratio of each electronic device)/(sum of height ratios of all electronic devices).

According to various embodiments, information that defines content portions may be created on the basis of such a divided size of each electronic device. For example, content portion defining information may be coordinate information that defines the left, top, right and bottom edges of each portion of content.

At operation 1646, the determined width ratio, height ratio, and divided size of content portion (or portion defining information) corresponding to each electronic device are transmitted together with the number of electronic devices in the multi-vision group.

At operation 1647, each electronic device may set a screen size for presenting content, based on the width and height ratios. According to various embodiments, the screen width size may be set on the basis of the width resolution of the electronic device. Also, the screen height size may be determined using the following equation: (the height resolution of the electronic device)*(the height of content/the width of content)*(the number of electronic devices in the multi-vision group)*(a height ratio)/1000.

At operation 1648, each electronic device may define a display portion from the screen having the above-set screen size, based on the determined divided size of content portion (or portion defining information) corresponding to each electronic device.

At operation 1649, each electronic device may display the corresponding content portion on the defined display portion.

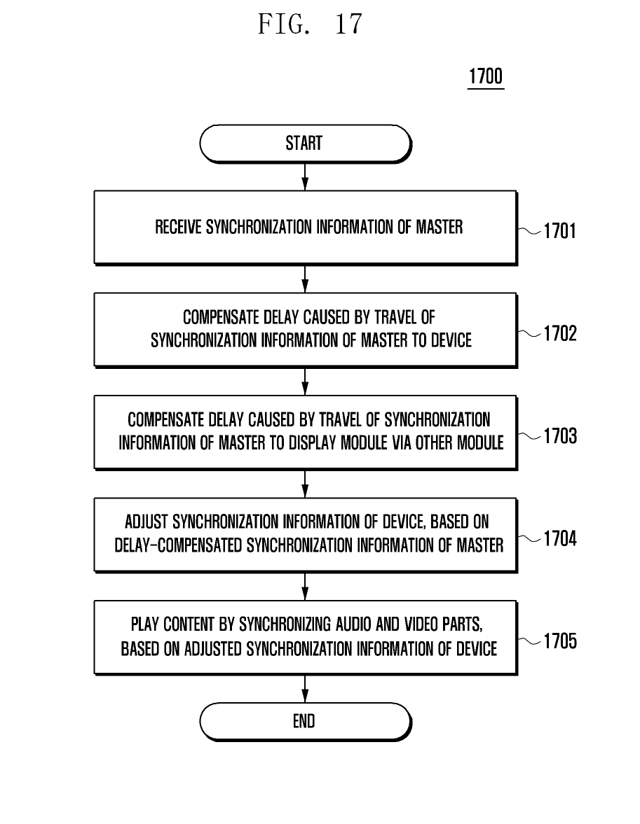

FIG. 17 is a flow diagram illustrating a method for synchronizing a plurality of electronic devices in a content presenting system according to an embodiment of the present disclosure.

In various embodiments of the present disclosure, the electronic device performing the method 1700 of FIG. 17 may be, for example, the electronic device 1300 shown in FIG. 13.

Referring to FIG. 17, a synchronization signal processing module (e.g., 1319 in FIG. 13) of the electronic device may receive the synchronization information of a master electronic device (e.g., master electronic device 1110 in FIG. 11) from such a master electronic device at operation 1701. The synchronization information of the master electronic device may include, for example, a video clock (or time stamp), an audio clock (or time stamp), a display module clock (or time stamp), a system clock (or time stamp), and the like of the master.

At operation 1702, the synchronization signal processing module (e.g., 1319 in FIG. 13) of the electronic device may compensate a delay caused by the travel of the synchronization information of the master electronic device (e.g., master electronic device 1110 in FIG. 11) from the master electronic device to the electronic device, based on a difference between a system clock of the master electronic device and a system clock of the electronic device.

At operation 1703, the synchronization signal processing module (e.g., 1319 in FIG. 13) of the electronic device may compensate a delay caused by the travel of the synchronization information of the master electronic device (e.g., master electronic device 1110 in FIG. 11) to a display module of the electronic device via any other module of the electronic device after being received at the electronic device, based on a difference between a system clock of the electronic device and a display module clock of the electronic device.

At operation 1704, the synchronization signal processing module (e.g., 1319 in FIG. 13) of the electronic device may adjust the synchronization information (e.g., an audio clock, a display module clock, a video clock, etc.) of a slave electronic device, based on the delay-compensated synchronization information of the master electronic device. For example, the audio clock or the display module clock of the slave electronic device may be set to be the same value as the delay-compensated display module clock of the master electronic device. In this case, if a difference between the delay-compensated display module clock of the master electronic device and the display module clock (or the audio clock) of the slave electronic device is greater than a reference value, audio data of a certain section may be skipped or muted for conforming to the display module clock of the master electronic device and output an audio part of content (i.e., audio rendering).

At operation 1705, the synchronization control module (e.g., 1316 in FIG. 13) of the electronic device may play the content by synchronizing audio and video parts at a display module of the slave electronic device, based on the adjusted synchronization information of the slave electronic device. For example, the synchronization control module of the electronic device may adjust the video clock of the slave electronic device to conform to the display module clock (or the audio clock) of the slave electronic device, and a video renderer (e.g., 1318 in FIG. 13) of the electronic device may play a video part of content (i.e., video rendering).

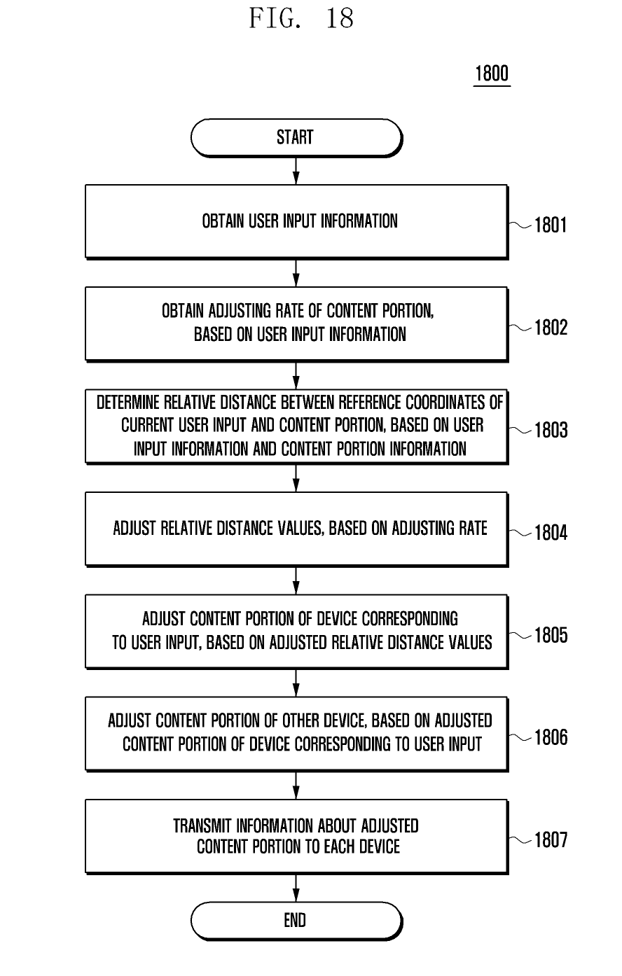

FIG. 18 is a flow diagram illustrating a method for adjusting a content portion in a multi-vision mode according to an embodiment of the present disclosure.

In various embodiments of the present disclosure, the electronic device performing the method 1800 of FIG. 18 may be, for example, an electronic device (e.g., the master 1100 in FIG. 11) including therein the multi-vision module 1200 shown in FIG. 12.

Referring to FIG. 18, the electronic device may obtain user input information (e.g., reference coordinates for zooming, variation of coordinates in a pinch drag, an enlarging or reducing rate, etc.) created by a user input (e.g., a pinch-zooming input) for one of the electronic devices in the multi-vision group at operation 1801. According to various embodiments, in case such a user input occurs at any other electronic device (e.g., the slave electronic device 1120 in FIG. 11), the electronic device may receive the user input information corresponding to the user input from that electronic device through a communication module (e.g., the communication module 1116 in FIG. 11). In case such a user input occurs at the electronic device (e.g., the master 1100 in FIG. 11) that performs this method 1800, the electronic device may receive the user input information corresponding to the user input from any other module (e.g., the input module 1113 in FIG. 11) thereof.

At operation 1802, the electronic device may obtain an adjusting rate (e.g., an enlarging or reducing rate) of specific content portion, based on the user input information (e.g., variation of coordinates). According to various embodiments, if such an adjusting rate itself is received as the user input information from an electronic device at which the user input (e.g., pinch-zooming input) occurs at operation 1801, this operation 1802 may be skipped.

At operation 1803, the electronic device may determine a relative distance between reference coordinates of a current user input and a content portion, based on the user input information (e.g., reference coordinates) and the content portion information of the electronic device corresponding to the user input. According to various embodiments, the electronic device may determine relative distance values (dl, dt, dr, and db) between the reference coordinates (x, y) of the user input and the content portion as shown in Equation 1, based on coordinate information, as the content portion information, which defines the left, top, right and bottom edges of the content portion.

dl=x−left;

dt=y−top;

dr=right−x;

and

db=bottom−y. Equation 1

At operation 1804, the electronic device may adjust the determined relative distance values between the reference coordinates of the user input and the content portion, based on the obtained adjusting rate (e.g., an enlarging or reducing rate) of the content portion. For example, the determined relative distance values (dl, dt, dr, and db) may be adjusted to (dl′, dt′, dr′, and db′) as shown in Equation 2.

dl′=dl/l;

dt′=dt/t;

dr′=dr/r;

and

db′=db/b. Equation 2

At operation 1805, the electronic device may adjust the content portion of the electronic device corresponding to the user input, based on the adjusted relative distance values (dl′, dt′, dr′, and db′). For example, the coordinates (L, T, R, B) and size (width, height) of the content portion of the electronic device corresponding to the user input may be determined by means of adjustment as shown in Equation 3.

L=x−dl′;

T=y−dt′;

R=x+dr′;

B=y+db′;

width=R−L;

and

height=T−B. Equation 3

At operation 1806, the electronic device may adjust the content portion of some electronic device other than the electronic device corresponding to the user input among the electronic devices the operating mode of which is a multi-vision mode, based on the adjusted content portion of the electronic device corresponding to the user input. For example, the coordinates (Lᵢ, Tᵢ, Rᵢ, Bᵢ) and size (widthᵢ, heightᵢ) of the content portion of the i-th left electronic device from the electronic device corresponding to the user input may be determined as shown in Equation 4.

Lₐ=L−width*i;

Tᵢ=T;

Rᵢ=Lᵢ₋₁;

Bᵢ=B;

widthᵢ=Rᵢ−Lᵢ;

and

heightᵢ=Tᵢ−Bᵢ. Equation 4

Additionally, the coordinates (Lⱼ, Tⱼ, Rⱼ, Bⱼ) and size (widthⱼ, heightⱼ) of the content portion of the j-th right electronic device from the electronic device corresponding to the user input may be determined as shown in Equation 5.

Lⱼ=Rⱼ₋₁;

Tⱼ=T;

Rⱼ=R+width*j;

Bⱼ=B;

widthⱼ=Rⱼ−Lⱼ;

and

heightⱼ=TⱼBⱼ. Equation 5

At operation 1807, the electronic device may transmit, through a communication module (e.g., the communication module 1040 in FIG. 10), information about the corresponding adjusted content portion to each electronic device the operating mode of which is a multi-vision mode.

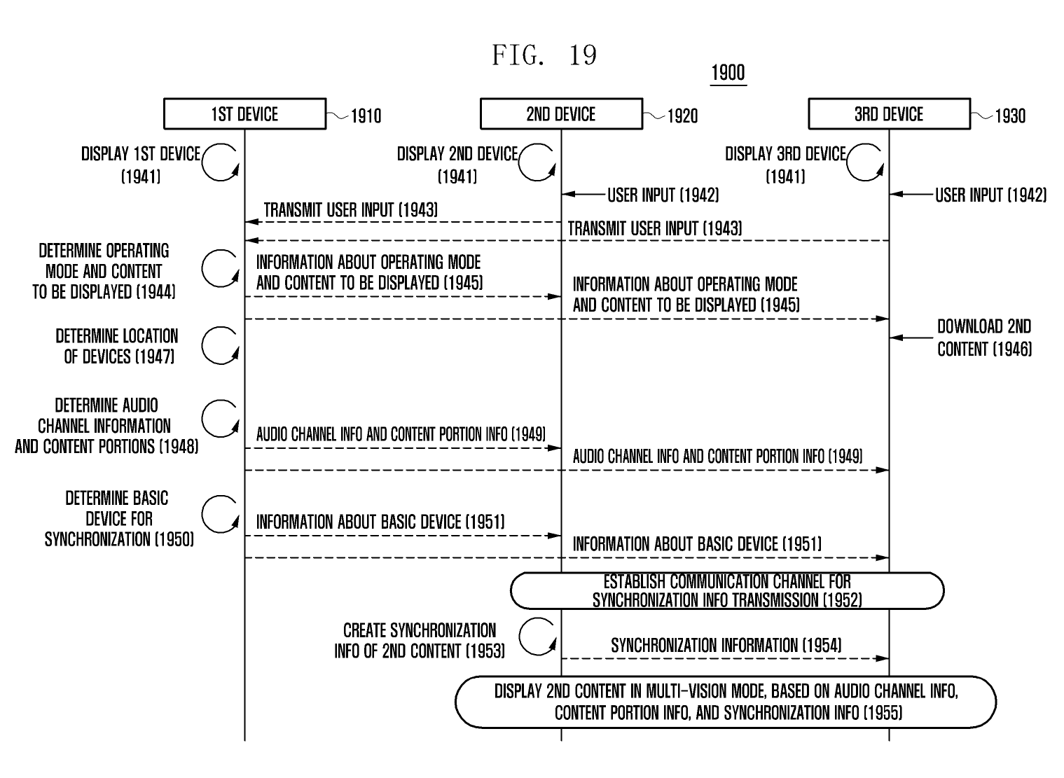

FIG. 19 is a flow diagram illustrating a process of displaying a plurality of contents at a plurality of multi-vision groups according to an embodiment of the present disclosure.

In various embodiments of the present disclosure, the first electronic device 1910 of a content presenting system 1900 of FIG. 19 may be, for example, an electronic device (e.g., the master 1100 in FIG. 11) including therein the multi-vision module 1200 shown in FIG. 12.

Referring to FIG. 19, at operation 1941, a first electronic device 1910, a second electronic device 1920 and a third electronic device 1930 may display (e.g., play) the first content, the second content and the third content, respectively.

At operation 1942, each of the second and third electronic devices 1920 and 1930 may recognize a user input (e.g., a drag input from a part of some panel of the third electronic device 1930 to a part of some panel of the second electronic device 1920).

At operation 1943, each of the second and third electronic devices 1920 and 1930 may transmit the recognized (e.g., detected) user input to the first electronic device 1910.

At operation 1944, an operating mode determining module (e.g., 1220 in FIG. 12) of the first electronic device 1910 may determine the operating modes of the second and third electronic devices 1920 and 1930, based on the user input recognized (e.g., detected) by the second and third electronic devices 1920 and 1930. In case the operating modes of the second and third electronic devices 1920 and 1930 are determined as a multi-vision mode, the second content displayed at the second electronic device 1920 or the third content displayed at the third electronic device 1930 may be determined as content to be displayed in a multi-vision mode.

At operation 1945, a communication module (e.g., 1116 in FIG. 11) of the first electronic device 1910 may transmit the determined operating modes to the second and third electronic devices 1920 and 1930, and if the operating mode is determined as a multi-vision mode, may also transmit information (e.g., link information for download of content) about content to be displayed in a multi-vision mode.

At operation 1946, if the second content is determined as content to be displayed in a multi-vision mode, the third electronic device 1930 may download the second content on the basis of the information about content received at operation 1945.

At operation 1947, a location adjusting module (e.g., 1230 in FIG. 12) of the first electronic device 1910 may determine the locations of electronic devices, the operating mode of which is a multi-vision mode, based on the user input information and the operating mode.

At operation 1948, a display portion determining module (e.g., 1240 in FIG. 12) of the first electronic device 1910 may determine audio channel information and content portions respectively corresponding to the second and third electronic devices 1920 and 1930 the operating mode of which is a multi-vision mode, based on the determined locations thereof.

At operation 1949, the communication module (e.g., 1116 in FIG. 11) of the first electronic device 1910 may transmit the determined audio channel information and content portions to the second and third electronic device 1920 and 1930 the operating mode of which is a multi-vision mode.

At operation 1950, a synchronization information creating module (e.g., 1260 in FIG. 12) of the first electronic device 1910 may determine, as a basic electronic device for synchronization, one of the second and third electronic devices 1920 and 1930 that will display the second content in a multi-vision mode, based on the operating mode and content to be displayed.

At operation 1951, the communication module (e.g., 1116 in FIG. 11) of the first electronic device 1910 may transmit information about the determined basic electronic device for synchronization to the second and third electronic devices 1920 and 1930 which will display the second content in a multi-vision mode.

At operation 1952, a communication channel for transmission of synchronization information may be established between the second and third electronic devices 1920 and 1930.

At operation 1953, the second electronic device 1920 which is determined as a basic electronic device for synchronization may create synchronization information of the second content from the playback of the second content at operation 1955. In this case, the second electronic device 1920 not only may perform a slave function, but also may further include some sub-modules (e.g., the synchronization information creating module 1260 in FIG. 12) of the multi-vision module (e.g., 1200 in FIG. 12) to create synchronization information.

At operation 1954, the second electronic device 1920 may transmit the created synchronization information to the third electronic device 1930.

At operation 1955, each of the second and third electronic devices 1920 and 1930 may display the second content in a multi-vision mode, based on the audio channel information, the content portion information and the synchronization information.

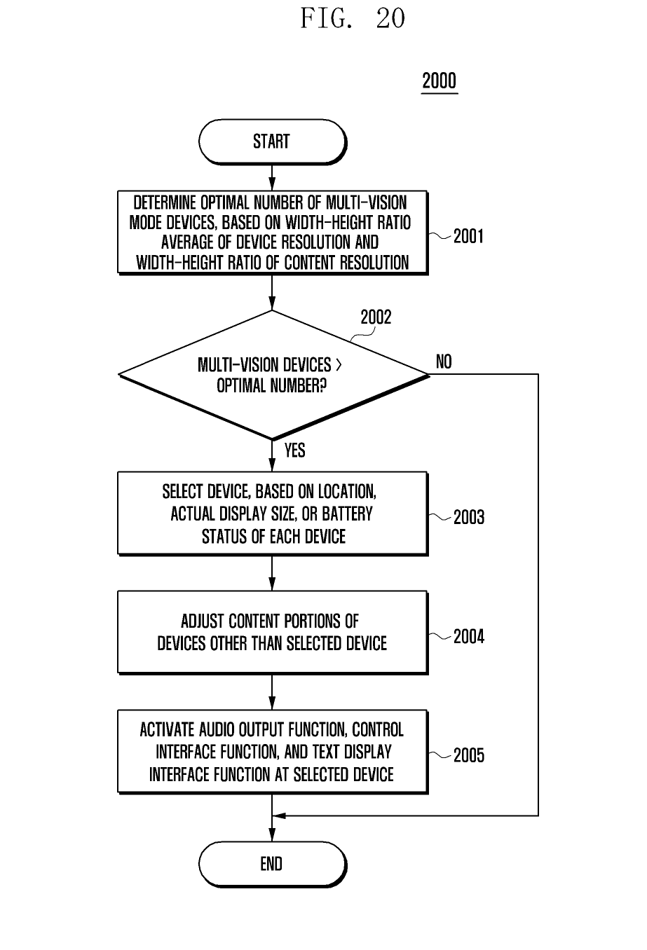

FIG. 20 is a flow diagram illustrating a method for controlling a multi-vision group to display an interface for providing an additional function through at least one electronic device according to an embodiment of the present disclosure.

In various embodiments of the present disclosure, the electronic device that performs the control method 2000 of FIG. 20 may be, for example, an electronic device (e.g., the master 1100 in FIG. 11) including therein the multi-vision module 1200 shown in FIG. 12.

In these embodiments, an interface may be at least one of an audio output interface for outputting audio through a functionally connected audio output unit (e.g., a speaker or an earphone), a control interface for receiving display control commands (e.g., a play, a seek, a pause, a stop, etc.) regarding the displayed content from a user, a text display interface for displaying text information (e.g., a caption) associated with the content, and the like.

Referring to FIG. 20, an electronic device selecting module (e.g., 1280 in FIG. 12) may determine the optimal number of electronic devices for operating in a multi-vision mode in view of the resolution of content, based on a width-height ratio average of the resolution of the electronic devices in the multi-vision group and a width-height ratio of the resolution of the content at operation 2001.

At operation 2002, the electronic device selecting module (e.g., 1280 in FIG. 12) may compare the current number of electronic devices belonging to the multi-vision group with the determined optimal number of electronic devices for operating in a multi-vision mode.

At operation 2003, if the current number of electronic devices is greater than the optimal number of electronic devices, the electronic device selecting module (e.g., 1280 in FIG. 12) may select at least one of the electronic devices that belong to the multi-vision group on the basis of the location, actual display size, and battery status of each electronic device that belongs to the multi-vision group.

According to various embodiments, the electronic device selecting module (e.g., 1280 in FIG. 12) may select a specific electronic device having the lowest battery or a battery status less than threshold from among electronic devices that belong to the multi-vision group. According to another embodiment, the electronic device selecting module may select a specific electronic device having the smallest display size from among electronic devices that belong to the multi-vision group. According to still another embodiment, the electronic device selecting module may select the leftmost or rightmost electronic device from among electronic devices that belong to the multi-vision group.

According to various embodiments, the above operations 2001 and 2002 may be skipped. In this case, a selection of electronic device may be performed out of consideration for the optimal number of electronic devices for operating in a multi-vision mode.

At operation 2004, a display portion determining module (e.g., 1240 in FIG. 12) may adjust content portions corresponding to electronic devices other than the selected electronic device from among electronic devices that belong to the multi-vision group.

At operation 2005, through an interface module (e.g., 1270 in FIG. 12), at least one of an audio output function, a control interface function, and a text display interface function may be activated for content at the selected electronic device. If the selected electronic device has the interface module, associated commands may be transmitted to another module (e.g., the content display control module 1115 in FIG. 11) in the same electronic device. If any other electronic device is selected, associated commands may be transmitted to that electronic device through the communication module (e.g., 1116 in FIG. 11).

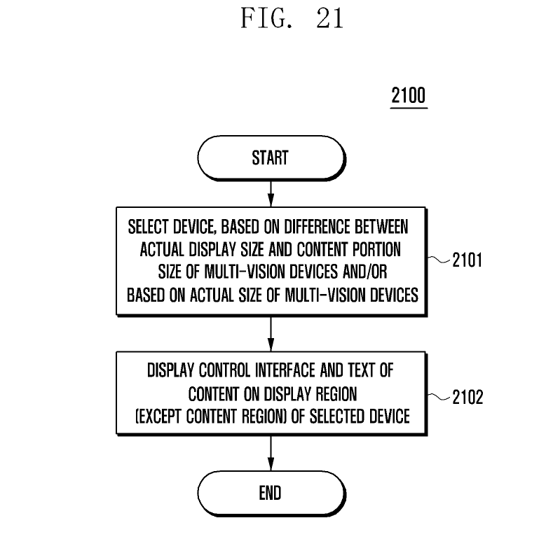

FIG. 21 is a flow diagram illustrating a method for controlling a multi-vision group to display an interface for providing any other function to part of a display region of at least one electronic device according to an embodiment of the present disclosure.

In various embodiments of the present disclosure, the electronic device that performs the control method 2100 of FIG. 21 may be, for example, an electronic device (e.g., the master 1100 in FIG. 11) including therein the multi-vision module 1200 shown in FIG. 12.

The control method 2100 in these embodiments may be performed in case the current number of electronic devices belonging to the multi-vision group is different from the optimal number of electronic devices for operating in a multi-vision mode and also in case a display size of at least some electronic devices belonging to the multi-vision group is different from a display size of the others.

Referring to FIG. 21, an electronic device selecting module (e.g., 1280 in FIG. 12) may select at least one of multi-vision electronic devices, based on a difference between an actual display size and content portion size of each electronic device in the multi-vision group and/or based on an actual size of each electronic device in the multi-vision group at operation 2101.

According to various embodiments, the electronic device selecting module (e.g., 1280 in FIG. 12) may select, from among electronic devices in the multi-vision group, an electronic device in which a difference between an actual display size and a content portion size is greater than a reference value. According to another embodiment, the electronic device selecting module may select an electronic device having the greatest actual display size from among electronic devices in the multi-vision group.

At operation 2102, through an interface module (e.g., 1270 in FIG. 12), at least one of a control interface for receiving display control commands (e.g., a play, a seek, a pause, a stop, etc.) regarding the displayed content from a user and a text display interface for displaying text information (e.g., a caption) associated with the content may be displayed. If the selected electronic device has the interface module, associated commands may be transmitted to another module (e.g., the content display control module 1115 in FIG. 11) in the same electronic device. If any other electronic device is selected, associated commands may be transmitted to that electronic device through the communication module (e.g., 1116 in FIG. 11).

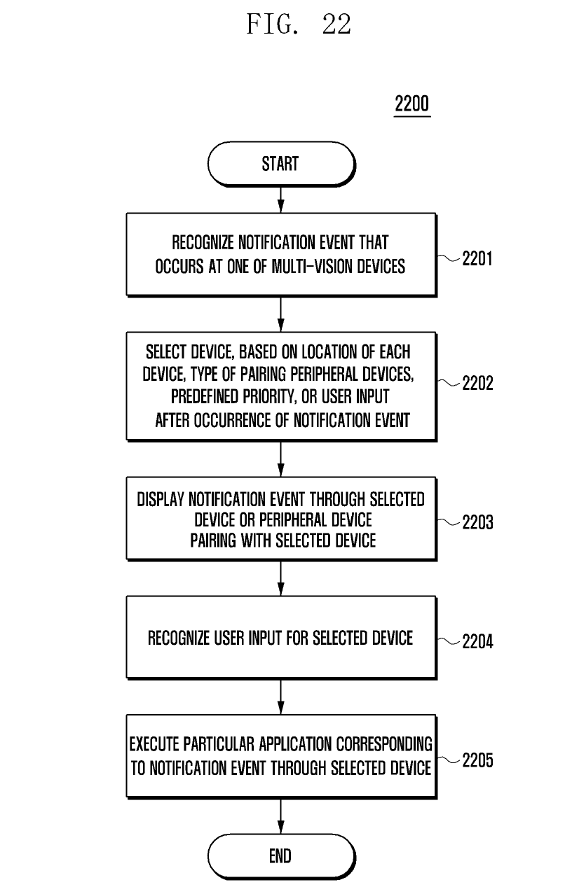

FIG. 22 is a flow diagram illustrating a method for controlling a multi-vision group to display a notification event, which happens at one electronic device, on any other selected electronic device according to an embodiment of the present disclosure.

In various embodiments of the present disclosure, the electronic device that performs the control method 2200 of FIG. 22 may be, for example, an electronic device (e.g., the master 1100 in FIG. 11) including therein the multi-vision module 1200 shown in FIG. 12.

Referring to FIG. 22, an electronic device selecting module (e.g., 1280 in FIG. 12) may recognize a notification event that occurs at one of electronic devices in the multi-vision group at operation 2201.

At operation 2202, the electronic device selecting module (e.g., 1280 in FIG. 12) may select an electronic device, based on at least one of the location information of each electronic device in the multi-vision group, the type of pairing peripheral electronic devices, the predefined priority, the type of the notification event, a user input after the occurrence of the notification event, and the like.

According to various embodiments, the electronic device selecting module (e.g., 1280 in FIG. 12) may select the leftmost or rightmost electronic device from among devices in the multi-vision group. According to another embodiment, the electronic device selecting module may select an electronic device pairing with a peripheral electronic device corresponding to the notification event from among electronic devices in the multi-vision group. For example, in case the notification event is the arrival of an incoming call, an electronic device pairing with a Bluetooth headset may be selected. According to still another embodiment, the priority of each electronic device in the multi-vision group may be defined in advance before the notification event is received, and the electronic device selecting module may select an electronic device having the highest priority. According to yet another embodiment, the electronic device selecting module may select an electronic device that recognizes a user input (e.g., a tap) after the notification event is received.

At operation 2203, through an interface module (e.g., 1270 in FIG. 12), the selected electronic device or a peripheral electronic device pairing with the selected electronic device may be controlled to display the notification event.

At operation 2204, through the interface module (e.g., 1270 in FIG. 12), a user input (e.g., a tap) for the selected electronic device may be recognized (e.g., detected).

At operation 2205, through the interface module (e.g., 1270 in FIG. 12), a specific service corresponding to the notification event may be offered by executing a particular application corresponding to the notification event at the selected electronic device. For example, in case the notification event is the arrival of an incoming call, an application that offers a call service may be executed. In case the notification event is the reception of a text message, an application for checking this message and creating a new message.

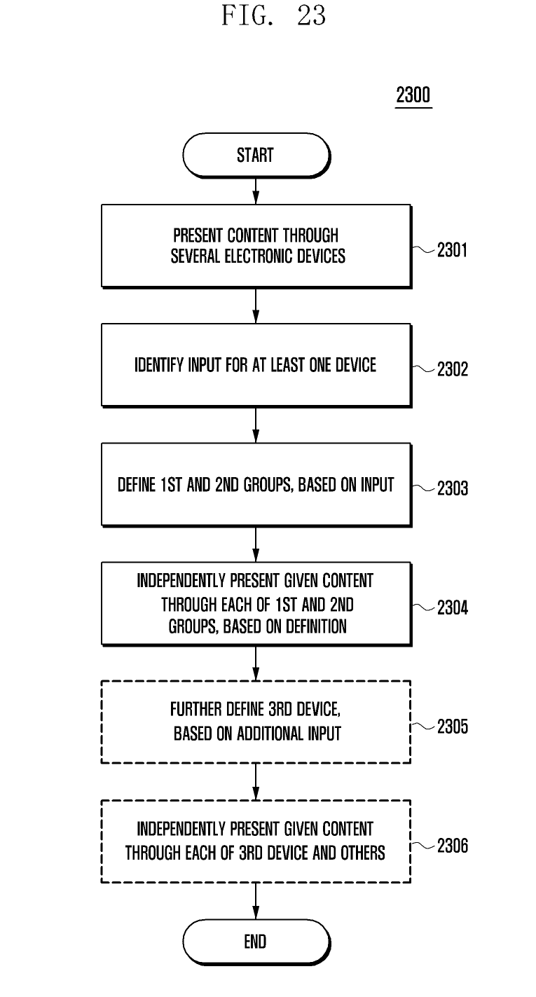

FIG. 23 is a flow diagram illustrating a method for presenting content according to an embodiment of the present disclosure.

Referring to FIG. 23, in method 2300, a content presenting system may present given content through a plurality of electronic devices having therein at least the first and second electronic devices at operation 2301. For example, the content presenting system may display the first portion of content through the first electronic device and also display the second portion of content through the second electronic device.

At operation 2302, a multi-vision module (e.g., 1114 in FIG. 11) may identify an input to at least one of the plurality of electronic devices while the content is displayed. This input may be at least one of a user gesture, a user touch, a user voice, and a distance between two of such electronic devices.

At operation 2303, the multi-vision module (e.g., 1114 in FIG. 11) may define, based on the input to at least one electronic device, the first group that contains therein the first electronic device, and the second group that contains therein the second electronic device. For example, the first group may be composed of the first electronic device and any other electronic device, or composed of the first electronic device only. Similarly, the second group may be composed of the second electronic device and any other electronic device, or composed of the second electronic device only.

At operation 2304, the content presenting system may independently present given content through each of the first and second groups, based on such a definition. Namely, the content may be displayed through the first group and simultaneously displayed through the second group. According to various embodiments, the content may be displayed as divided portions corresponding to the respective electronic devices assigned to at least one of the first and second groups. According to another embodiment, the content may be displayed on each of the electronic devices assigned to at least one of the first and second groups.

According to some embodiments, the content presenting method 2300 may further include operations 2305 and 2306.

At operation 2305, the multi-vision module (e.g., 1114 in FIG. 11) may further define, based on any additional input to at least one electronic device, the third group that contains therein the electronic device(s) of the first or second group. This additional input may be at least one of a user gesture, a user touch, a user voice, a distance between two of such electronic devices, and the like.

At operation 2306, the content presenting system may independently present the content through each of the third group and the others, based on such a further definition.

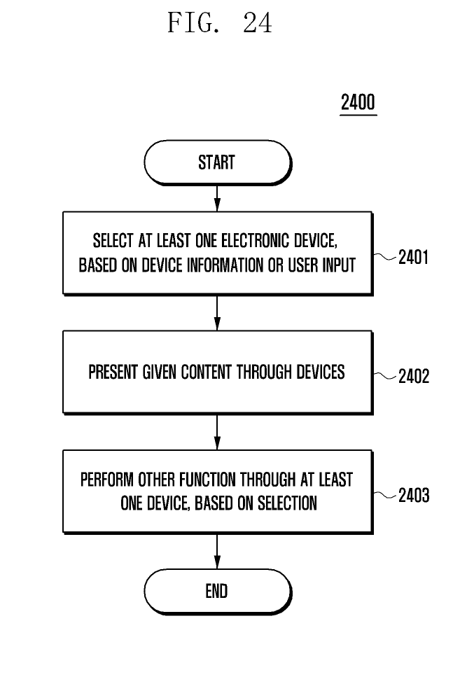

FIG. 24 is a flow diagram illustrating a method for presenting content according to an embodiment of the present disclosure.

Referring to FIG. 24, in method 2400, a multi-vision module (e.g., 1114 in FIG. 11) may select at least one electronic device among a plurality of electronic devices including at least the first and second electronic devices, based on at least one of information about the plurality of electronic devices and a user input for at least one of the plurality of electronic devices at operation 2401. Information about the electronic devices may include at least one of a display size of each electronic device, a battery status of each electronic device, a relative location of each electronic device, the type of pairing peripheral devices, a predefined priority, and the like.

At operation 2402, the content presenting system may present given content through the plurality of electronic devices. For example, the first portion of the content may be displayed through the first electronic device, and the second portion of the content may be displayed through the second electronic device.

At operation 2403, the content presenting system may perform another function associated with content presentation through at least one electronic device, based on a selection at operation 2401. This operation 2403 may be performed simultaneously with operation 2402.

In these embodiments, the above-mentioned other function may be a specific function, which is directly or indirectly associated with content presentation, from among various functions other than a display function of content through a display unit functionally connected to the electronic device.

According to various embodiments, an interface for recognizing a user's control input on displayed content may be presented through at least part of a display region of the selected electronic device. For example, while one part of content is displayed through one part of the display region of the selected electronic device and the other part of content is displayed through the other part of the display region, an interface for recognizing a user input for controlling the display of content may be offered to the other part of the display region. Alternatively, the selected electronic device may offer such an interface to the other part of the display region without displaying content on the other part of the display region.

According to various embodiments, an audio part of content may be outputted through the selected electronic device alone (Namely, the other electronic devices may not output an audio part of content). In this case, the selected electronic device may display at least some content and simultaneously output some audio content. Alternatively, the selected electronic device may output only some audio content without displaying content.

According to various embodiments, text of content may be displayed through at least part of the display region of the selected electronic device. For example, in case the content contains therein a video part sequentially displayed and caption text synchronized with the video part and thus sequentially displayed, such caption text may be displayed.

According to various embodiments, the selected electronic device may execute a particular application corresponding to a notification event that occurs at any other electronic device. For example, the notification event may be the arrival of an incoming call, the reception of a text message, and the like.

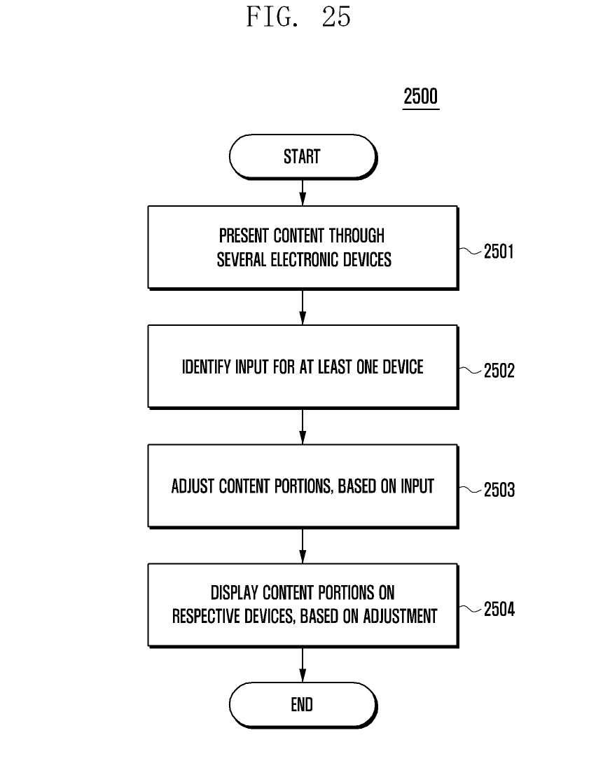

FIG. 25 is a flow diagram illustrating a method for presenting content according to an embodiment of the present disclosure.

Referring to FIG. 25, in method 2500, a content presenting system may present given content through the plurality of electronic devices having at least the first and second electronic devices. For example, the first portion of the content may be displayed through the first electronic device, and the second portion of the content may be displayed through the second electronic device at operation 2501.

At operation 2502, a multi-vision module (e.g., 1114 in FIG. 11) may identify a user input for at least one of the plurality of electronic devices while the content is displayed. For example, at least one of a user gesture, a user touch and a hovering may be received as such an input. At this time, coordinate values or variation thereof corresponding to the user input may be obtained.

At operation 2503, the multi-vision module (e.g., 1114 in FIG. 11) may adjust at least one of content portions, e.g., the first and second portions, based on the identified input. According to various embodiments, in case each of the first and second portions has corresponding coordinate values, these coordinate values may be adjusted.

At operation 2504, a content presenting system may display the content portions corresponding to the respective electronic devices, based on adjustment at operation 2503. For example, the first content portion may be displayed through the first electronic device, and the second content portion may be displayed through the second electronic device. At this time, due to the adjustment, at least one of the first and second portions may be different from the corresponding portion displayed at operation 2501.

Various operations in the methods discussed hereinbefore and shown in FIGS. 14 to 25 may be performed sequentially, in parallel, repeatedly, or heuristically. Further, such operations may be performed in different orders. Some of such operations may be skipped, and any other operation may be added.

According to various embodiments, a content presenting method may include presenting given content through a plurality of electronic devices having the first electronic device and the second electronic device. The presenting may include displaying the first portion of the content through the first electronic device and displaying the second portion of the content through the second electronic device. The method may further include identifying an input for at least one electronic device from among the plurality of electronic devices while the content is displayed. The method may further include, based on the input, defining the first group including the first electronic device and the second group including the second electronic device from among the plurality of electronic devices. The method may further include presenting the content through the first and second groups independently of each other.

According to various embodiments, the presenting independently may include displaying the content through the first group and simultaneously displaying the content through the second group.

According to various embodiments, each of the first and second groups may include therein a plurality of electronic devices.

According to various embodiments, the identifying may include receiving the above-mentioned input that may include at least one of a user gesture, a user touch, a user voice, a distance between two or more electronic devices, and the like.

According to various embodiments, the method may also include further defining, based on an additional input for at least one of the plurality of electronic devices, the third group that contains therein an electronic device of the first group or an electronic device of the second group. The method may further include offering independently the content through each of the third group and the others.

According to various embodiments, the further identifying may be performed in response to, as the additional input, at least one of a user gesture, a user touch, a user voice, a distance between two or more electronic devices, and the like.

According to various embodiments, the presenting independently may include dividing the content into portions corresponding to the plurality of electronic devices assigned to at least one of the first and second groups and displaying each portion on each electronic device.

According to various embodiments, the dividing may be performed on the basis of at least one of a size of a display functionally connected to each of the electronic devices assigned to at least one group, the number of the electronic devices assigned to at least one group, a resolution of the content, and the like.

According to various embodiments, the presenting independently may include displaying the content on each of the plurality of electronic devices contained in at least one of the first and second groups.

According to various embodiments, the presenting independently may include simultaneously presenting at least part of the content at each electronic device other than the first electronic device in the first and second groups, based on synchronization information created at the first electronic device.

According to various embodiments, the synchronization information may include at least one of time stamp information associated with a current content display portion of the first electronic device and current time information of the first electronic device.

According to various embodiments, the synchronization information may include the time stamp information associated with the current content display portion of the first electronic device and the current time information of the first electronic device. In this case, the presenting independently may include adjusting the time stamp information at each electronic device other than the first electronic device in the first and second groups, based on the current time information of the first electronic device and current time information of each of the other electronic devices.

According to various embodiments, the content may include a plurality of contents having the first and second contents.

According to various embodiments, the presenting independently may include displaying the first content through the first group and displaying the second content through the second group.

According to various embodiments, the presenting independently may include displaying at least part of the first content at each electronic device other than the first electronic device in the first group, based on the synchronization information created at the first electronic device, and displaying at least part of the second content at each electronic device other than the second electronic device in the second group, based on the synchronization information created at the second electronic device

According to various embodiments, the content may include multimedia content. In this case, the presenting independently may include displaying data corresponding to the first display portion of the multimedia content through the first group and, at the same time, displaying data corresponding to the second display portion of the multimedia content through the second group.

According to various embodiments, a content presenting method may include selecting at least one electronic device from among a plurality of electronic devices having the first and second electronic devices, based on at least one of information about the plurality of electronic devices and a user input for at least one of the electronic devices. The method may further include presenting given content through the plurality of electronic devices such that the first portion of the content is displayed through the first electronic device and the second portion of the content is displayed through the second electronic device. Also, the method may further include performing a particular function associated with presentation of the content through the selected at least one electronic device.

According to various embodiments, the selecting of the at least one electronic device may be performed on the basis of at least one of a display size of each electronic device, a battery status of each electronic device, a relative location of each electronic device, the type of pairing peripheral electronic devices, a predefined priority, and the like.

According to various embodiments, the particular function may be performed together with the presenting of the content.

According to various embodiments, the performing of the particular function may include presenting an interface for recognizing a user's control input corresponding to displaying of the content through at least part of a display region of the selected electronic device.

According to various embodiments, the presenting of the content may include displaying at least part of the content through one part of the display region of the selected electronic device, and the performing of the particular function may include displaying at least part of the content and simultaneously offering an interface for recognizing a user's control input corresponding to the displaying of the content through the other part of the display region of the selected electronic device.

According to various embodiments, the performing of the particular function may include outputting audio of the content through the selected electronic device.

According to various embodiments, the performing of the particular function may include displaying text of the content through at least part of the display region of the selected electronic device.

According to various embodiments, the content contains therein sequentially displayed video and caption text synchronized with the video and thus sequentially displayed. In this case, the displaying of the text may include displaying the caption text.

According to various embodiments, the performing of the particular function may include executing, through the selected electronic device, a particular application corresponding to a notification event that occurs at another electronic device.

According to various embodiments, the notification event may include at least one of the arrival of an incoming call, the reception of a text message, and the like.

According to various embodiments, a content presenting method may include presenting given content through a plurality of electronic devices having the first electronic device and the second electronic device. The presenting may include displaying the first portion of the content through the first electronic device and displaying the second portion of the content through the second electronic device. The method may further include adjusting, based on a user input for at least one of the plurality of electronic devices, at least one of the first and second portions. The method may further include, based on such adjustment, displaying the first and second portions through the first and second electronic devices, respectively.

According to various embodiments, the adjusting may be based on at least one of coordinate values corresponding to the user input and variation of the coordinate values.

According to various embodiments, each of the first and second portions may include coordinates corresponding to the first or second portion, and the adjusting may include adjusting the coordinates corresponding to at least one of the first and second portions.

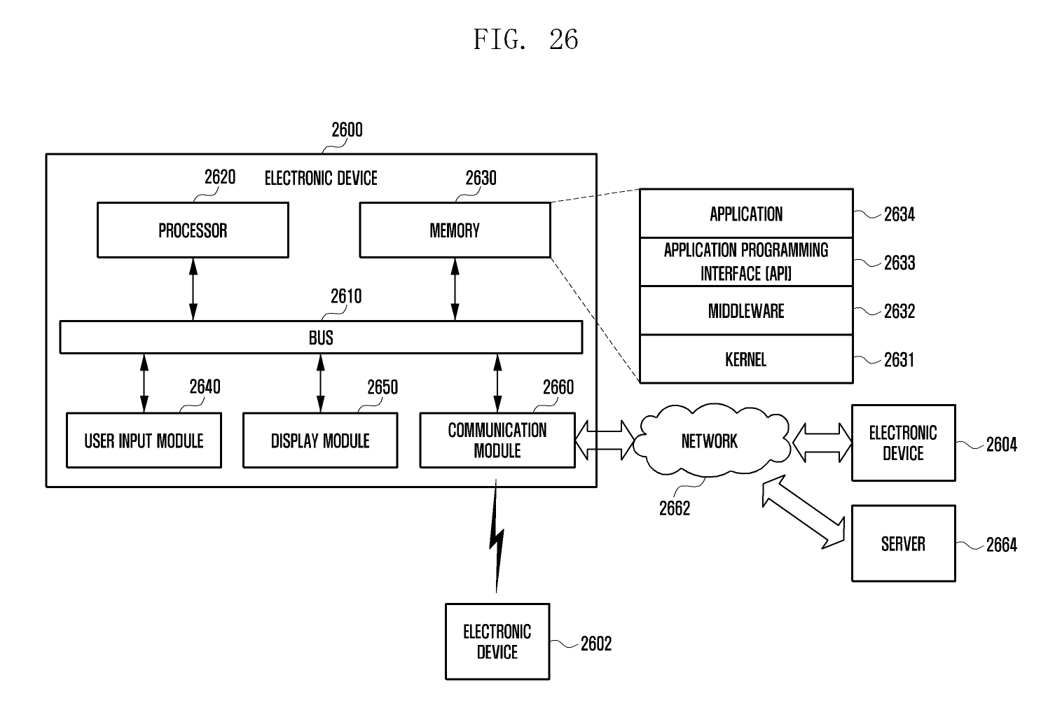

FIG. 26 is a block diagram illustrating an electronic device according to an embodiment of the present disclosure.

Referring to FIG. 26, the electronic device 2600 may include a bus 2610, a processor 2620, a memory 2630, a user input module 2640, a display module 2650, and a communication module 2660.

The bus 2610 may be a circuit designed for connecting the above-discussed elements and communicating data (e.g., a control message) between such elements.

The processor 2620 may receive commands from the other elements (e.g., the memory 2630, the user input module 2640, the display module 2650, the communication module 2660, etc.) through the bus 2610, interpret the received commands, and perform the arithmetic or data processing based on the interpreted commands.

The processor 2620 may execute a multi-vision module (e.g., the multi-vision module 1010 or 1114). Therefore, the processor 2620 may control one or more of a plurality of electronic devices such that given content may be presented through the plurality of electronic devices.

The memory 2630 may store therein commands or data received from or created at the processor 2620 or other elements (e.g., the user input module 2640, the display module 2650, the communication module 2660, etc.). The memory 2630 may include programming modules such as a kernel 2631, a middleware 2632, an application programming interface (API) 2633, and an application 2634. Each of the programming modules may be composed of software, firmware, hardware, and any combination thereof.

The memory 2630 may store therein, for example, information about the plurality of electronic devices for presenting content.

The kernel 2631 may control or manage system resources (e.g., the bus 2610, the processor 2620, the memory 2630, etc.) used for performing operations or functions of the other programming modules, e.g., the middleware 2632, the API 2633, or the application 2634. Additionally, the kernel 2631 may offer an interface that allows the middleware 2632, the API 2633 or the application 2634 to access, control or manage individual elements of the electronic device 2600.

The middleware 2632 may perform intermediation by which the API 2633 or the application 2634 communicates with the kernel 2631 to transmit or receive data. Additionally, in connection with task requests received from the applications 2634, the middleware 2632 may perform a load balancing for the task request by using technique such as assigning the priority for using a system resource of the electronic device 2600 (e.g., the bus 2610, the processor 2620, the memory 2630, etc.) to at least one of the applications 2634.

The API 2633 which is an interface for allowing the application 2634 to control a function provided by the kernel 2631 or the middleware 2632 may include, for example, at least one interface or function for a file control, a window control, an image processing, a text control, and the like.

The user input module 2640 may receive commands or data from a user and deliver them to the processor 2620 or the memory 2630 through the bus 2610. The display module 2650 may display thereon an image, a video or data.

The communication module 2660 may perform a communication between the electronic device 2600 and another electronic device 2602 and/or 2604 or between the electronic device 2600 and a server 2664. The communication module 2660 may support a short-range communication protocol (e.g., WiFi, Bluetooth (BT), Near Field Communication (NFC), etc.) or a network communication 2662 (e.g., Internet, Local Area Network (LAN), Wide Area Network (WAN), a telecommunication network, a cellular network, a satellite network, Plain Old Telephone Service (POTS), etc.). Each of electronic devices 2602 and 2604 may be the same type of electronic device as or a different type of electronic device from the electronic device 2600.

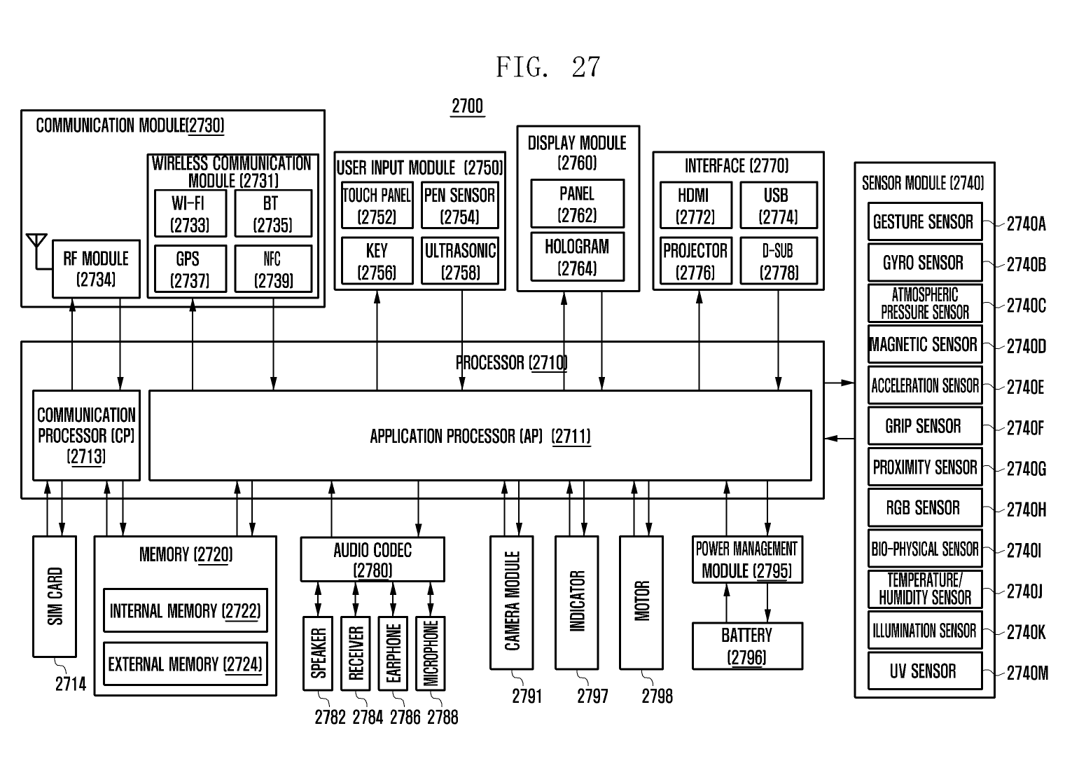

FIG. 27 is a block diagram illustrating hardware according to an embodiment of the present disclosure. In various embodiments of the present disclosure, the hardware 2700 may be, for example, the electronic device 2600 shown in FIG. 26.

Referring to FIG. 27, the hardware 2700 may include at least one processor 2710, a subscriber identification module (SIM) card 2714, a memory 2720, a communication module 2730, a sensor module 2740, a user input module 2750, a display module 2760, an interface 2770, an audio codec 2780, a camera module 2791, a power management module 2795, a battery 2796, an indicator 2797, and a motor 2798.

The processor 2710 may include at least one Application Processor (AP) 2711 and/or at least one Communication Processor (CP) 2713. The processor 2710 may be, for example, the processor 2620 shown in FIG. 26. Although FIG. 27 shows the AP 2711 and the CP 2713 contained together in the processor 2710, the AP 2711 and the CP 2713 may be contained in different IC packages, respectively. In various embodiments, the AP 2711 and the CP 2713 may be integrated into a single IC package.

The AP 2711 may drive an operating system or applications, control a plurality of hardware or software components connected thereto, and also perform processing and operation for various data including multimedia data. The AP 2711 may be formed of System-on-Chip (SoC), for example. According to various embodiments, the AP 2711 may further include a Graphic Processing Unit (GPU) (not shown).

The CP 2713 may perform functions of managing a data link and converting a communication protocol in a communication between an electronic device (e.g., the electronic device 2600 in FIG. 26) having the hardware 2700 and another electronic device connected through a network. The CP 2713 may be formed as a System on Chip (SoC), for example. According to various embodiments, the CP 2713 may perform at least part of a multimedia control function. Using the SIM card 2714, for example, the CP 2713 may perform identification and authentication of the electronic device in a communication network. Additionally, the CP 2713 may offer, to a user, services such as a voice call, a video call, a text message, a packet data, and the like.

Meanwhile, the CP 2713 may control the data transmission and reception of the communication module 2730. Although FIG. 27 shows that elements such as the CP 2713, the power management module 2795, or the memory 2720 are separated from the AP 2711, in various embodiments, the AP 2711 may be formed to contain therein at least part (e.g., the CP 2713) of the above elements.

According to various embodiments, the AP 2711 or the CP 2713 may load commands or data received from a nonvolatile memory connected thereto or from at least one of the other elements into a volatile memory to process them. Additionally, the AP 2711 or the CP 2713 may store data received from or created at one or more of the other elements in the nonvolatile memory.

The SIM card 2714 may be a specific card formed of SIM and may be inserted into a slot located at a certain place of the electronic device. The SIM card 2714 may contain therein an Integrated Circuit Card Identifier (ICCID) or an IMSI (International Mobile Subscriber Identity).

The memory 2720 may include an internal memory 2722 and an external memory 2724. The memory 2720 may be, for example, the memory 2630 shown in FIG. 26. The internal memory 2722 may include, for example, at least one of a volatile memory (e.g., Dynamic (DRAM RAM), Static RAM (SRAM), Synchronous DRAM (SDRAM), etc.) and a nonvolatile memory (e.g., One Time Programmable ROM (OTPROM), Programmable ROM (PROM), Erasable and Programmable ROM (EPROM), Electrically Erasable and Programmable (EEPROM ROM), mask ROM, flash ROM, NAND flash memory, NOR flash memory, etc.). In various embodiments, the internal memory 2722 may have the form of a Solid State Drive (SSD). The external memory 2724 may include a flash drive, e.g., Compact Flash (CF), Secure Digital (SD), Micro-SD (Micro Secure Digital), Mini-SD (Mini Secure Digital), xD (eXtreme Digital), memory stick, or the like.

The communication module 2730 may include therein a wireless communication module 2731 and/or a Radio Frequency (RF) module 2734. The communication module 2730 may be, for example, the communication module 2660 shown in FIG. 26. The wireless communication module 2731 may include, for example, a WiFi module 2733, a BT module 2735, a GPS (Global Positioning System) module 2737, and an NFC module 2739. For example, the wireless communication module 2731 may offer a wireless communication function using a wireless frequency. Additionally or alternatively, the wireless communication module 2731 may include a network interface (e.g., an LAN card) or a modem for connecting the hardware 2700 with a network (e.g., Internet, LAN, WAN, a telecommunication network, a cellular network, a satellite network, POTS, etc.).

The RF module 2734 may transmit and receive data, e.g., RF signals or any other electric signals. Although not shown, the RF module 2734 may include a transceiver, a Power Amp Module (PAM), a frequency filter, an Low Noise Amplifier (LNA), or the like. Also, the RF module 2734 may include any component, e.g., a wire or a conductor, for transmission of electromagnetic waves in a free air space.

The sensor module 2740 may include, for example, at least one of a gesture sensor 2740A, a gyro sensor 2740B, an atmospheric sensor 2740C, a magnetic sensor 2740D, an acceleration sensor 2740E, a grip sensor 2740F, a proximity sensor 2740G, a Red, Green, Blue (RGB) sensor 2740H, a bio-physical (e.g., biometric) sensor 2740I, a temperature-humidity sensor 2740J, an illumination sensor 2740K, and an ultraviolet (UV) sensor 2740M. The sensor module 2740 may measure a certain physical quantity or detect an operating status of the electronic device, and convert such measured or detected information into electrical signals. Additionally or alternatively, the sensor module 2740 may include, for example, an E-nose sensor (not shown), an electromyography (EMG) sensor (not shown), an electroencephalogram (EEG) sensor (not shown), an electrocardiogram (ECG) sensor (not shown), or a finger scan sensor (not shown). Also, the sensor module 2740 may include a control circuit for controlling one or more sensors equipped therein.

The user input module 2750 may include a touch panel 2752, a digital pen sensor 2754, a key 2756, or an ultrasonic input tool 2758. The user input module 2750 may be, for example, the user input module 2640 shown in FIG. 26. The touch panel 2752 may recognize a touch input in a manner of a capacitive type, a resistive type, an infrared type, or an ultrasonic type. Also, the touch panel 2752 may further include a controller (not shown). In case of a capacitive type, a physical contact or proximity may be recognized (e.g., detected). The touch panel 2752 may further include a tactile layer. In this case, the touch panel 2752 may offer a tactile feedback to a user.

The digital pen sensor 2754 may be formed in the same or similar manner as receiving a touch input or by using a separate recognition sheet. The key 2756 may include, for example, a keypad or a touch key. The ultrasonic input tool 2758 is a specific device capable of identifying data by sensing sound waves with a microphone 2788 in the electronic device through a pen that generates ultrasonic signals, thus allowing wireless recognition. According to various embodiments, using the communication module 2730, the hardware 2700 may receive a user input from any external device (e.g., a network, a computer, or a server).

The display module 2760 may include a panel 2762 and/or a hologram 2764. The display module 2760 may be, for example, the display module 2650 shown in FIG. 26. The panel 2762 may be, for example, a Liquid Crystal Display (LCD), an Active Matrix Organic Light Emitting Diode (AM-OLED), or the like. The panel 2762 may have a flexible, transparent or wearable form. The panel 2762 may be formed of a single module with the touch panel 2752. The hologram 2764 may show a stereoscopic image in the air using interference of light. According to various embodiments, the display module 2760 may further include a control circuit for controlling the panel 2762 or the hologram 2764.

The interface 2770 may include, for example, a High-Definition Multimedia Interface (HDMI) 2772, a Universal Serial Bus (USB) 2774, a projector 2776, and/or a D-subminiature (D-sub) 2778. Additionally or alternatively, the interface 2770 may include, for example, an SD card/MMC Card interface (not shown), or an Infrared Data Association (IrDA) interface (not shown).

The audio codec 2780 may perform a conversion between sounds and electric signals. The audio codec 2780 may process sound information inputted or outputted through a speaker 2782, a receiver 2784, an earphone 2786, or a microphone 2788.

The camera module 2791 is a device capable of obtaining still images and moving images. In various embodiments, the camera module 2791 may include at least one image sensor (e.g., a front sensor or a rear sensor), a lens (not shown), an Image Signal Processor (ISP), not shown, and/or a flash LED (not shown).

The power management module 2795 may manage electric power of the hardware 2700. Although not shown, the power management module 2795 may include, for example, a Power Management Integrated Circuit (PMIC), a charger IC, and/or a battery gauge.

The PMIC may be formed of an IC chip or SoC. Charging may be performed in a wired or wireless manner. The charger IC may charge the battery 2796 and prevent overvoltage or overcurrent from a charger. In various embodiments, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount (i.e., capacity) of the battery 2796 and a voltage, current or temperature in a charging process. The battery 2796 may store or create electric power therein and supply electric power to the hardware 2700. The battery 2796 may be, for example, a rechargeable battery.

The indicator 2797 may show thereon a current status (e.g., a booting status, a message status, or a recharging status) of the hardware 2700 or of its part (e.g., the AP 2711). The motor 2798 may convert an electric signal into a mechanical vibration.

Although not shown, the hardware 2700 may include a specific processor (e.g., GPU) for supporting a mobile TV. This processor may process media data that comply with standards of Digital Multimedia Broadcasting (DMB), Digital Video Broadcasting (DVB), or media flow. Each of the above-discussed elements of the hardware 2700 may be formed of one or more components, and its name may be varied according to the type of the electronic device. The hardware may be formed of at least one of the above-discussed elements without some elements or with additional other elements. Some of the elements may be integrated into a single entity that still performs the same functions as those of such elements before integrated.

As fully discussed hereinbefore, the content presenting methods and devices in various embodiments may freely toggle a content display mode such that at least one electronic device or electronic device group among a plurality of electronic devices that have presented certain content in a multi-vision mode can present such content independently of the other devices. Namely, even though a certain electronic device is separated from the others, the content may be displayed independently of or simultaneously with the other electronic devices.

Additionally, the content presenting methods and devices in various embodiments may display content through electronic devices having different display sizes or perform other function associated with content presentation through any extra display region when the number of electronic devices exceeds the optimal number corresponding to the resolution of content.

Further, when any event such as the arrival of an incoming call occurs at a certain device among multi-vision devices during a display of content in a multi-vision mode, the content presenting methods and devices in various embodiments may execute a particular application corresponding to such an event through any other electronic device.

Also, the content presenting methods and devices in various embodiments may adjust content portions of the respective electronic devices operating in a multi-vision mode in response to a user input for a selected device among such devices.

The above-described embodiments can be implemented in hardware, firmware or via the execution of software or computer code that can be stored in a recording medium such as a CD ROM, a DVD, a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity.

The above-discussed method is described herein with reference to flowchart illustrations of user interfaces, methods, and computer program products according to embodiments of the present disclosure. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method comprising:
selecting at least one electronic device from among a plurality of electronic devices, including a first electronic device and a second electronic device, based on at least one of information about the plurality of electronic devices and a user input for at least one of the electronic devices;
presenting content through the plurality of electronic devices such that a first portion of the content is displayed through the first electronic device and a second portion of the content is displayed through the second electronic device; and
performing a particular function associated with presentation of the content through the selected at least one device.

2. The method of claim 1, wherein the selecting of the at least one device is performed on the basis of at least one of a display size of each electronic device, a battery status of each electronic device, a relative location of each electronic device, the type of pairing peripheral devices, and a priority.

3. The method of claim 1, wherein the particular function is performed together with the presenting of the content.

4. The method of claim 1, wherein the performing of the particular function includes presenting an interface for recognizing a user's control input corresponding to displaying of the content through at least part of a display region of the selected device.

5. The method of claim 1, wherein the presenting of the content includes displaying at least part of the content through one part of a display region of the selected device, and
wherein the performing of the particular function includes displaying at least part of the content and simultaneously offering an interface for recognizing a user's control input corresponding to the displaying of the content through the other part of the display region of the selected device.

6. The method of claim 1, wherein the performing of the particular function includes outputting audio of the content through the selected device.

7. The method of claim 1, wherein the performing of the particular function includes displaying text of the content through at least part of a display region of the selected device.

8. The method of claim 7, wherein the content comprises sequentially displayed video and caption text synchronized with the video and sequentially displayed, and
wherein the displaying of the text includes displaying the caption text.

9. The method of claim 1, wherein the performing of the particular function includes executing, through the selected device, a particular application corresponding to a notification event that occurs at other device.

10. The method of claim 9, wherein the notification event includes at least one of the arrival of an incoming call and the reception of a text message.

11. A method comprising:
presenting content through a plurality of electronic devices, including a first electronic device and a second electronic device, such that a first portion of the content is displayed through the first electronic device and a second portion of the content is displayed through the second electronic device;
adjusting, based on a user input for at least one of the plurality of electronic devices, at least one of the first and second portions; and
based on the adjusting, displaying the first and second portions through the first and second electronic devices, respectively.

12. The method of claim 11, wherein the adjusting is based on at least one of coordinate values corresponding to the user input and variation of the coordinate values.

13. The method of claim 11, wherein each of the first and second portions includes coordinates corresponding to the first or second portion, and
wherein the adjusting includes adjusting the coordinates corresponding to at least one of the first and second portions.

14. An electronic device comprising:
a memory configured to store information about a plurality of electronic devices having a first electronic device and a second electronic device; and
at least one processor configured to execute a multi-vision module,
wherein the multi-vision module is configured to:
select at least one device from among the plurality of electronic devices, based on at least one of information about the plurality of electronic devices and a user input for at least one of the electronic devices;
present content through the plurality of electronic devices such that a first portion of the content is displayed through the first electronic device and a second portion of the content is displayed through the second electronic device; and
control one or more electronic devices among the plurality of electronic devices such that a particular function associated with presentation of the content is performed through the selected at least one device.

15. The electronic device of claim 14, wherein the multi-vision module is further configured to control the one or more devices such that the particular function is performed together with the presenting of the content.

16. The electronic device of claim 14, wherein the multi-vision module is further configured to control the one or more devices such that an interface is presented to recognize a user's control input corresponding to playback of the content through at least part of a display region of the selected device.

17. The electronic device of claim 14, wherein the multi-vision module is further configured to control the one or more devices such that audio of the content is outputted through the selected device.

18. The electronic device of claim 14, wherein the multi-vision module is further configured to control the one or more devices such that text of the content is displayed through at least part of a display region of the selected device.

19. The electronic device of claim 14, wherein the multi-vision module is further configured to allow a particular application corresponding to a notification event, occurring at another device, to be executed through the selected device.

20. An electronic device comprising:
a memory configured to store information about a plurality of electronic devices including a first electronic device and a second electronic device; and
at least one processor configured to execute a multi-vision module,
wherein the multi-vision module is configured to:
identify an input for at least one device from among the plurality of electronic devices while content is presented through the plurality of electronic devices such that a first portion of the content is displayed through the first electronic device and a second portion of the content is displayed through the second electronic device;
based on the input, adjust at least one of the first and second portions; and
control at least one of the electronic devices such that the first and second portions are displayed through the first and second electronic devices, respectively.
